(19) United States
(12) Patent Application Publication
(10) Pub. No.: US 2018/0018709 A1
(43) Pub. Date: Jan. 18, 2018

(54) INFORMATION SPREAD IN SOCIAL NETWORKS THROUGH SCHEDULING SEEDING METHODS

(71) Applicant: Ramot at Tel-Aviv University Ltd., Tel Aviv (IL)

(72) Inventors: ALON SELA, Rehovot (IL); IRAD BEN GAL, Herzliya (IL); EREZ SHMUELI, Beer Sheva (IL); DMITRI GOLDENBERG, Ramat Gan (IL)

(21) Appl. No.: 15/607,509

(22) Filed: May 28, 2017

Related U.S. Application Data
(60) Provisional application No. 62/343,240, filed on May 31, 2016.

(51) Int. Cl. G06Q 30/02; H04M 3/22; G06Q 50/00; H04M 3/42; G06F 17/30

(52) U.S. Cl. CPC G06Q 30/0271; H04M 3/42161; G06F 17/30861; G06Q 50/01; H04M 3/2263

(57) ABSTRACT

A method for information spread in one or more social networks, the method may include receiving or generating social network information that represents members of the one or more social networks and links between the members; repeating, for each point in time out of multiple points in time, the steps of: determining, in response to budget constraints and current statuses of the members, and the current influence vectors of the members social circle, at least one target member that is non-infected during the point of time and should be infected before the next point in time, to provide an increase in the final number of infected members; wherein the statuses of the members comprises (i) infected and infectious, (ii) non-infected and (iii) infected and non-infectious; and sending, at a cost, the information to the at least one target member, before the next point in time.

### CROSS REFERENCE

This application claims priority from U.S. provisional patent 62/343,240 filing date May 31, 2016 which is incorporated herein by reference.

### BACKGROUND

Social networks provide a digital platform that has already changed the course of history. A known example includes President Obama's pre-election social network activities that contributed to his successful campaign and lead ultimately to his election (M. T. Moore, “Study: Obama tops Romney in online activity,” USA Today, 2012). Another known example is the Arab Spring (2010-2011), in which riots and anti-regime activities were initiated and organized through social media (P. N. Howard and et. al, “Opening Closed Regimes—What Was the Role of Social Media During the Arab Spring?,” Washington, 2011), resulting in protests of millions of people around the Arab world in the attempt to bring down their local regimes, or the recent use of president Donald Trump in Twitter. These examples demonstrate the impact of social media and explain why current academic research is focusing heavily on studying different aspects of social networks.

One highly studied aspect of social networks is the identification of influential nodes representing influential parties in the network. This domain mainly focuses on the topological characteristics of the network and less on the content that is being spread. Numerous centrality measures that quantify diverse types of influence of nodes were defined and studied. Frequently used centrality measures include the PageRank, the Eigenvector centrality, the Betweenness centrality, the Kats centrality, and various clustering coefficient measures. Each of these measures has its own advantage and represents a different type of influence that characterizes a node. See, for example, M. J. Newman, Networks: An Introduction., Oxford, UK: Oxford University Press., 2010; S. Borgatti, “Centrality and Network Flow,” Social Networks (Elsevier), vol. 27, p. 55-71, 2005; Aral, S., Muchnik, L., & Sundararajan, A., “Optimal Network Seeding in the Presence of Homophily,” Engineering Social Contagions, February 2013.

Centrality measures are often used to evaluate seeding policies. “Seeding” is the act of “infecting” specific nodes prior to the spread, and then inspecting (e.g., by simulations) how the spread evolves dynamically. It has been argued that seeding alone, according to various centrality measures, cannot guarantee an efficient spread (Aral, S., Muchnik, L., & Sundararajan, A, “Optimal Network Seeding in the Presence of Homophily,” Engineering Social Contagions, February 2013). Recent works investigate which sets of nodes should be “seeded” simultaneously to increase the information spread in a network (e.g., see Shakarian, P., Eyre, S., & Paulo, D., “A scalable heuristic for viral marketing under the tipping model.,” Social Netw. Analys. & Mining, vol. 3, no. 4, pp. 1225-1248, 2013).

Yet, although several such works studied the spread of information through social networks by various seeding policies and by using several centrality measures, only few theoretical works (F. Chierichetti, J. Kleinberg and A. Panconesi, “How to Schedule a Cascade in an Arbitrary Graph,” in Proceedings of the 13th ACM Conference on Electronic Commerce, 2012) have addressed the question of timing. That is, not only the identification of the correct set of nodes to be seeded at the beginning of the spread (i.e., finding “which nodes to seed”) but also choosing the specific time points for each seeding (i.e., choosing “when to seed which nodes”).

### SUMMARY

According to an embodiment of the invention there may be provided a method for information spread in one or more social networks, the method may include receiving or generating social network information that represents members of one or more social networks and links between the members; repeating, for each point in time out of multiple points in time, the steps of: determining, in response to budget constraints and current statuses of the members (i.e., whether the members already adopted the product or service or have made any explicit action that advances them towards adoption), at least one target member that is non-infected during the point of time and should be infected before the next point in time, to provide an increase in the number of infected members; wherein the statuses of the members comprises (i) infected and infectious, (ii) non-infected and (iii) infected and non-infectious; and sending, at a cost, the information to at least one target member, before the next point of time.

The method may include a use of the following algorithm as a recommendation system to a call center, to recommend which customers to call at what time, while receiving as an input their social network, and who adopted the offer that was offered and at what point in time, in order to compute the next time frame recommendation.

The increase in the number of infected members may be a maximal number of infected members.

The statuses further comprise a seeded member where the seeding was refused.

The statuses further comprise a member that was seeded and a predefined period between seeding attempts has not passed.

The social network information may be a social network graph and wherein the members are nodes of the social network graph.

The method may include updating the statuses of the members before the next point of time.

The method may include comprising receiving feedback about an actual status of the members before at least one next point in time and wherein the updating of the statuses may be responsive to the feedback

The comprising receiving feedback about an estimated status of the members before at least one next point in time and wherein the updating of the statuses may be responsive to the feedback

The sending of the information results in one or more infection attempts.

The updating of the statuses may be responsive to an estimated relationship between infection attempts and infection success.

The updating of the statuses may be based on an estimated and/or stochastic model of a relationship between infection attempts and infection success.

The updating of the statuses may be based on a deterministic model of a relationship between infection attempts and infection success or a stochastic model.

The deterministic model of the relationship between infection attempts and infection success dictates that a non-infected member becomes infected once a predefined number of neighbor members of the non-infected member are infected and infectious (using either a deterministic or stochastic model).

The method may include receiving feedback about a status of a target member wherein the status may be indicative of whether the target member adopted a product and/or service which was advertised by the information sent to the target member.

The updating of the statuses may be based on a probabilistic model of a relationship between infection attempts and infection success.

The probabilistic model of the relationship between infection attempts and infection success dictates that the probability of a non-infected member to become infected increases with the number of its neighbor members that are infected and infectious.

The probabilistic model of the relationship between infection attempts and infection success dictates that the probability of a non-infected member to become infected increases with the number of its infected neighbors until a defined number and does not further change.

The method may include a change in the status of an infected and infectious member to infected and non-infectious, after a predefined period of time; (e.g., “forgetting effect”).

The social network information may be a social network graph and wherein the members are nodes of the social network graph; wherein the nodes are arranged in clusters; wherein the determination of nodes to seed may be responsive to the clusters.

The method may include a use of the methods for computing the attractiveness of a person within the social network in each point in time, as defined by the methods of scoring above, and precisely, by

The method may include defining a score by the methods defined above, or methods based on these methods, which determine the time of seeding according to the existing current potential of a node along its probability of accepting a seed,

The method may include (but not obligatory includes) the computation of the negative influence caused by, for example, reoccurring trials to seed a node in two points in time that are too close, thus, creating a negative influence (e.g., “nagging effect”).

The method may include in the computation method of the score the concept by which a score of a node may be built from its expected value if the seed succeeds, along its value loss if it fails (in the stochastic case).

The method may include the combination of these methods on top of existing client clustering methods (BI) for defining potential customers for an offer, and building the scheduled seeding mechanism on top and not as a replacement of such existing clustering mechanisms.

The method may include different and similar scoring methods, which define nodes to be seeded, (i.e. given an offer) as a factor of the current adoption map (what node adopted in the network at each period of time), while computing the potential of each node as based on nodes that it can positively influence their future seeding, along the probability of such a seeding to succeed in the current (next or near future) points in time, along the negative influence if this offer is refused in the next point in time.

The method can be augmented with additional information about the nodes (parties), such as their demographics and previous purchase history. All of these properties together can be used to train a machine learning algorithm to create a model for determining the sets of nodes to be seeded at each time frame.

The suggested method and computer readable medium provides an improvement in computer technology by finding a cost effective and efficient method for virtually infecting members and thus saves network resources by preventing unneeded traffic to members that are not likely to adopt the product or service that the messages relate to.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates various graphs according to an embodiment of the invention;

FIG. 2 shows an average number of infected nodes for the five seeding heuristics (named INITIAL_GEC, INITIAL_RANDOM, SCHEDULED_GEC, SCHEDULED_RANDOM, SCHEDULED_SOCIAL), over 250 executions of the adjusted SI epidemic model on the DBLP Citation network, on different initial conditions, according to an embodiment of the invention;

FIG. 3 illustrates the seeding and evolution steps in a mesh according to an embodiment of the invention;

FIG. 4 illustrates Seeding by Initial_Eigenvector_Seeding (upper) which is one of the best known method to detect influencers, vs. Scheduled_Clustering (lower) according to an embodiment of the invention;

FIG. 5 illustrates the average final number of infected nodes by the Scheduled_Clustering heuristic (right bar) and the Initial_Eigenvector_Seeding heuristic (left bar) in 256 executions (left) according to an embodiment of the invention;

FIGS. 6-9 illustrate various methods according to various embodiments of the invention;

FIG. 10A illustrates a network, member devices and various computers according to an embodiment of the invention;

FIGS. 10B and 11 illustrate states of a node according to an embodiment of the invention;

FIG. 12 illustrates performances according to an embodiment of the invention;

FIG. 13 illustrates performances of various algorithms according to an embodiment of the invention;

FIG. 14 illustrates performances of various algorithms according to an embodiment of the invention;

FIG. 15 illustrates performances of various algorithms according to an embodiment of the invention;

FIG. 16 illustrates performances of various algorithms according to an embodiment of the invention;

FIG. 17 illustrates performances of various algorithms according to an embodiment of the invention;

FIG. 18 illustrates performances of various algorithms according to an embodiment of the invention;

FIG. 19 illustrates performances of various algorithms according to an embodiment of the invention;

FIG. 20 illustrates performances of various algorithms according to an embodiment of the invention;

FIG. 21 illustrates performances of various algorithms according to an embodiment of the invention; and

FIG. 22 illustrates a method according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

In this specification the term “social network” may be a digital social network such as Facebook, Twitter etc. . . . , or any other structure that defines relationships between people, for example, a network constructed from log files of phone calls, or a network simply constructed by asking people who their friends are, or by any method which captures the social interactions map of people or, any graph which defines social or influence connections, such as telephone calls of a telephone or cellular provider, or any graph which reflects social influence or social connection of any type, including but not limited to friendships, work connection, joint commercial interests, social encounters, in a digital or physical milieu, and the like.

The use of the correct scheduling of nodes in a network, can be used for the benefit of commercial firms that aim toward increasing their profits in markets where the competition demands a constant improvement in competitiveness.

Moreover, the benefit of timely seeding is not only limited to the influence in the network but also to the impact on the communication overload in those networks. Current communication networks are flooded with information and there is a growing need to reduce communication over networks. The reduction of information may prevent investing in unnecessary communication infrastructure and may reduce the cost of communication sessions.

It is a common belief that influential people/organizations/entities are those with many connections. In a social graph, these people are represented by nodes with a higher degree. However, some Network Science studies have identified better predictors for influence through centrality measures. The Eigenvector centrality measure, for example, has been found to be a good estimator for the ability of a node to spread information. Such theoretical results were empirically validated through large-scale experiments that inspected the adoption rate of rural banking loans in Indian villages (Banerjee, Abhijit, et al. “The diffusion of microfinance.” Science 341(6144), 2013). Information on loans plans were introduced to people in the social network of Indian rural village, and direct relations between the Eigenvector centrality measure of each person and his/her influence on the spread of information was detected.

Other important measures that influence the spread include local and global clustering coefficients. These measures estimate the degree of connectivity of a sub-group in the network and enable to detect communities by which information would spread with greater ease. Referring to clustering.

Common Models of Information Spread

Within the classical models that describe the spread of information are the Linear Threshold model and the Independent Cascade models. The Linear Threshold model, which was initially proposed by Mark Granovetter, assumes each node can be in one of two states: a state of being “infected” or in a state of being “non-infected”. In the Independent Cascade model, the probability that a node would become infected increases as more of its neighbors become infected. Let G=(V,A) be a social graph. After an initial seeding (setting some nodes as state=infected at time t=0) of nodes in V′εV, in each time step t; each node u might change its state according to the number of infected nodes within its neighbors δ(u). In this model, a node can only switch from a state of being non-infected to a state of being infected, but not vice versa. The goal is to find methods by which higher rates of nodes would be infected at the end of an infection phase that follows the seeding phase. The second model is the Independent Cascade model. Here, after seeding an initial set of nodes V′εV at t=0, each infected node has only one single time period in which it can infect other nodes in its neighbors' group. Each such infection trial has a predetermined probability to succeed.

The single period by which a node can infect others in the Independent Cascade model, fits well with the Limited Attention paradigm (Weng, et al. “Competition among memes in a world with limited attention.” Scientific reports 2 (2012)). This paradigm assumes that a portion of the incoming information would never be processed, and that the more time passed without information being processed, the less the probability that it will be processed later on.

The proposed model follows these two “classical” modes. Like the Independent Cascade model, it assumes a spread is possible only within a limited number of time steps. Yet, unlike the independent cascade model, it assumes the spread does not only occur in one single time step after the infection, but in a pre-defined number of steps. The model also follows the Linear Threshold model and assumes that the probability of a node being infected grows as more of its neighbors are infected.

The Power of Social Networks

Facebook's initial public offering (IPO) was set at a price of $38/share. This price represented a market value of $100 billion, and has doubled itself in about 2.5 years. This immense market value expresses the importance of social networks not only as a platform to spread personal posts and family pictures, but mostly as a platform for marketing and sales. Marketing improvement is indeed one of the major contribution aims of proposed method. The power of social network is based on the relationship between the group and the individual in that group. The group changes the individual through one's personal tendency to align with the opinion of the majority. Therefore, there is a big difference between an encounter of a new idea when one of the node's friends have accepted it, to its encounter while most members in one's social group have already accepted it. Developing effective temporal seeding policies that define which nodes should be approached at which point in time in order to influence more members of the social group is the main motivation behind the proposed Scheduled Seeding algorithm.

According to an embodiment of the invention a Scheduled-Seeding approach is provided that determines not only which nodes need to be seeded, but also at which point in time the seeding needs to occur. This approach is based on two psychological traits: (1) the tendency to follow others (herd behavior), and (2) the tendency to focus on news rather than on older information. Correct scheduling of messages to particular nodes at particular times can increase both the viral spread and its cost-effectiveness. Our simulations of this approach have shown to improve the rates of spread by over 23% in some cases. These findings are relevant to various industries, particularly in the telecommunications industry but not limited to, whereby estimations of the network's structure can be revealed. Enabling faster and more efficient information spread with a limited budget can help such organizations better achieve their goals.

Determining the correct timing for seeding is becoming more relevant nowadays as a result of the fast-paced world and the Limited Attention Paradigm. This paradigm assumes that a person cannot process the entire vast amount of information received due to his/her limited attention span and cognitive processing capacities. One cannot process the entire amount of information received within a required period of time, only a few messages can be fully processed. Therefore, it is highly important to choose wisely the set of messages that the user would be exposed to, and the time at which this exposure is performed to increase the message's effect.

The current application addresses the timing framework for information spread and proposes a Scheduled Seeding method that leads to a more efficient spread. The proposed method is based on concepts of herd behavior and adaptation to social norms.

The used algorithms synchronize and schedule the seeding efforts in a manner that increases social influence, by seeding particular nodes at specific times. We claim that a good time to seed a node is when enough (but not too many) of its neighbors have already been infected. If only few neighbors are infected, the social impact would be too weak. On the other hand, if too many neighbors are infected, although it would be easy to infect it, the potential influence of the node decreases, since most of its neighbors are already infected.

Results of simulation studies show that the proposed algorithms can increase the number of infected nodes in various networks by 25%-35%, compared to existing methods in which seeding occurs only at the initial stage of a spread. Accordingly, the proposed framework offers a useful and effective tool for organizations that wish to spread information with limited financial resources. Health organizations, for example, could use such tools to efficiently spread vital information on illness prevention and to increase the adoption rate of related health directives (e.g., STDs, Ebola, HIV, diabetes prevention early detected mammograms, call for vaccinations, etc.). Other potential organizations that might use such methods are telephone companies by which the network structure can be relatively easily revealed through their meta-data and log files, which can use the tools to improve their sales, or any organization which can gain insights into its customer's social relationships network.

The Proposed Model

We start by providing a formal definition for the Scheduling Seeding Problem, and presenting two methods used to improve the spread within a limited budget. The first is the SCHEDULED_SOCIAL method, and the second is the Latent Viral Marketing method. We follow by providing two preliminary heuristics for Scheduled Seeding. Finally, we demonstrate the superiority of our heuristics over the state-of-the-art Initial Seeding heuristic which seeds the nodes at the initial steps of the scheduling process.

Then, in the next section, we define the Viral Marketing Model, and propose similarly, the methods to improve the adoption rates is circumstances that meet this model.

Notation and Formal Problem Definition

G(V,E) A social graph G with |V|=n nodes vεV and |E|=m edges.
B The total budget B (without loss of generality it is assumed that seeding each node costs=1.
F(v) The current state of a node v where it is defined as

$$F ( v ) ≡ \{ \begin{matrix}0 Not Infected \\ 1 Infected and Infectious \\ 2 Infected but not Infectious\end{matrix} \}$$

O The number of time steps in which an infected node can infect other nodes (infectious period).
C The Infection Threshold is C; this, if C or more neighbors of v are infectious, node v becomes infected.
S The rate of infected nodes (%) at the end of the Scheduling-Seeding process.
F(v)* In models which prevent subsequent seed attempts after a customer rejects a seed attempt

$$F ( v ) ≡ \{ \begin{matrix}0 Not Infected \\ 1 Infected and Infectious \\ 2 Infected but not Infectious \\ 3 Cannot be Seeded\end{matrix} \}$$

O Period in which the node is infectious to others.

Dynamics

At the first stage, we assume members in a network can only change their state from Not Infected to Infected, in a deterministic way. This assumption is to be later relaxed. If C neighbors of v are infected, the state of v; F(v) changes to 1; state Infected and Infectious. As long as this is the state, the node can influence other nodes in its surroundings. After O time steps from this change, the node changes its state again to F(v)=2; e.g. it is still infected but does not spread the idea to its neighbors anymore.

Similarly to previous studies, we define the success rate of the contagious process (denoted by S) as the proportion of infected nodes at equilibrium, i.e., when nodes no longer change their state from non-infected to infected.

The objective in the Scheduled-Seeding Problem is to maximize the success rate S in a given network by identifying up to N nodes to be seeded at each time step, such that the total number of seeded nodes would not exceed the available budget B, over T periods of time. The problem can be formulated as a classical scheduling problem and solved by combinatorial optimization. Similar scheduling problems in the OR literature are known to be NP-hard, and since actual network sizes are often of millions or billions of nodes, fast heuristics, such as the proposed method is provided.

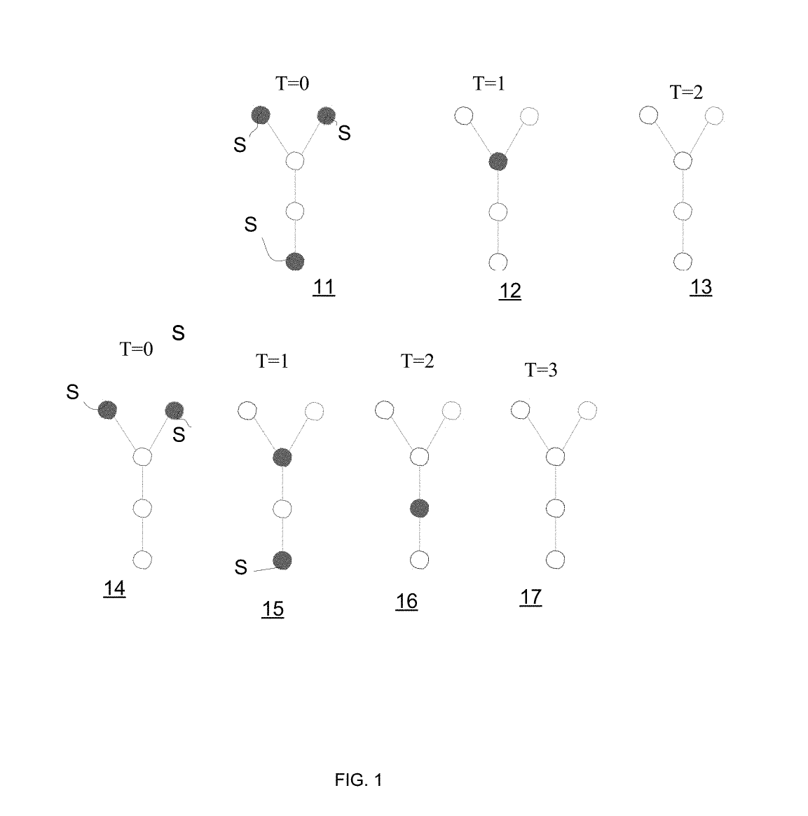

The following toy example demonstrates how a higher success rate is obtained by scheduled seeding of the network nodes. We assume a network with n=4 nodes and m=4 edges as depicted in FIG. 1 (graphs 11-17) and the following parameters: O=1, C=2 and B=3. Note that under these assumptions and by using an initial seeding policy, e.g. by seeding B=3 nodes at t=0. It is impossible to infect all five nodes in the network, as seen in FIG. 1 (Upper). Moreover, if one selects the high-degree nodes for the initial seeding (i.e., the node of degree 3, the node of degree 2 and any of the nodes of degree 1, as proposed by many seeding strategies, it is impossible to infect more than three nodes in the network. Yet, under the scheduled seeding approach, it is possible to infect all five nodes, as seen in FIG. 1 (Lower). Note that the value of information that is obtained by observing the nodes' state and accordingly seeding the next set of nodes is much more noticeable when the size of the networks grows and the infectious process is probabilistic rather than deterministic as in this algorithm for information scheduling.

A demonstrative network of 5 nodes is presented in FIG. 1. The aim is to infect all 5 nodes with a budget of 3 seeds. The viral infection rule is such that if two neighbors of a node adopt an idea, the node adopts this idea as well as a result of social influence. While it is not possible to reach this goal, (see 11, 12, and 13 in FIG. 1 as one example of such trial), using a scheduling approach (see 14, 15, 16, 17 in FIG. 1) would result in an infection of all nodes. Please note that in FIG. 1, a node that is seeded is marked by a red full circle, an infected node is marked by a red empty circle, and a non-infected node is marked by an empty blue circle.

The intuition behind the SCHEDULED_SOCIAL heuristic is to seed the nodes that have the highest potential to infect other nodes at any given time. More specifically, after every iteration, a score is given to the uninfected nodes according to their potential to infect others in case they would be seeded. Accordingly, those nodes with the highest scores are selected and seeded. The score for a node, say v₁, is calculated by evaluating the score of its neighbors. The weight of each one of the neighbors of v₁, say v₂, is calculated based on its current state, i.e., the number of v₂'s neighbors that need to be infected, in order for v₂ to become infected. Since the likelihood of v₂ to become infected increases significantly with the number of its infected neighbors, an exponential scoring scheme is used. Algorithm 1 describes how the score calculation for each node at each iteration.

In FIG. 1 it is assumed that, in order for an infection to occur, two of the node's neighbours need to be infected. A strategy that seeds 3 nodes at time (t=0), would result in at most a total of 4 infected nodes (graphs 11-13). Nevertheless, a scheduled-seeding strategy (graphs 14-17) which seeds two upper nodes at (t=0), resulting in a natural infection, then seeding the lowest node at (t=1), would result in a natural infection of one more node and a final state of all 5 nodes infected.

The algorithm that was developed to solve the Scheduled Seeding problem is named the Scheduled_Clustering algorithm. It was tested by an agent based simulation over several networks and different initial conditions, while using the dynamics of natural infection as described above.

In the following sections the algorithms will be presented along results of simulation runs for different networks, initial budget settings and oblivion levels.

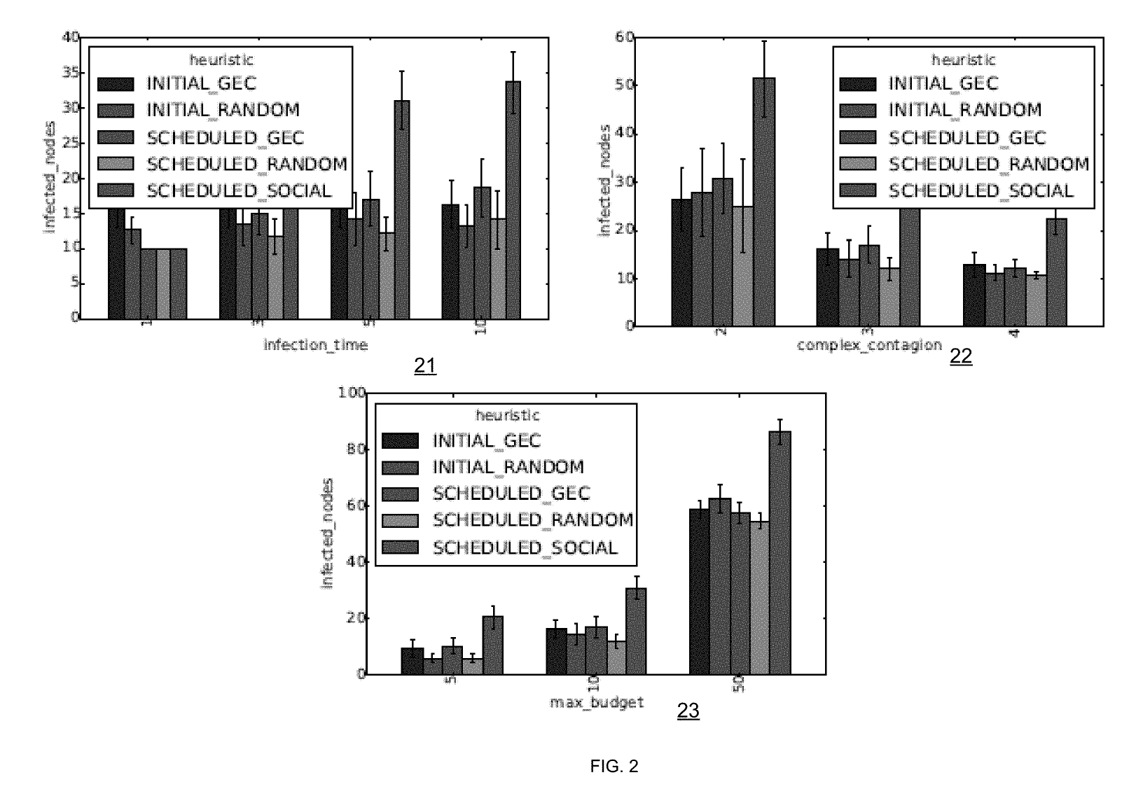

The suggested heuristics, the SCHEDULED_SOCIAL and the SCHEDULED_CLUSTERING are based on seeding the nodes that have the highest potential of infecting other nodes at any given time. More specifically, at each timestamp a score is given to each uninfected node according to its potential of infecting other nodes in case it would be seeded. The node scored the highest is then seeded. In order to evaluate our heuristic, we first simulated the variant of the SI epidemic model over different network structures, when using our SCHEDULED SOCIAL heuristic and four other baseline seeding heuristics: the INITIAL GEC heuristic generates a group eigenvector centrality score for each node, and seeds the nodes with the highest scores at the initial iteration; In the SCHEDULED GEC heuristic, at each timestamp we choose one node with the highest group eigenvector centrality that is non-infected; The INITIAL RANDOM and SCHEDULED RANDOM heuristics are very similar, except that the group eigenvector centrality score is replaced by a random score. Our evaluation results have shown that the SCHEDULED SOCIAL obtained 25%-35% more infected nodes than the other baseline heuristics. For example, FIG. 2 shows (graphs 21, 22 and 22 indicative of infection time, maximal budget and complex contagion) the average number of infected nodes for the five seeding heuristics, over 250 executions of the adjusted SI epidemic model on the DBLP Citation network.

The Scheduled_Clustering Algorithm

The intuition behind the SCHEDULING_CLUSTERING algorithm is that sometimes it is better to initiate seeding in a new cluster (e.g., open a new market) rather than continue seeding in an existing saturated cluster (invest in a saturated market). Similarly to the previous algorithm, this algorithm starts by an initial seeding of N seeds. We chose an initial seeding of nodes with high Eigenvector Centrality values. These infectious nodes; denoted by {S0}, will influence a second layer of non-infected nodes; denoted by {S1}. This set consists of nodes that would not be infected naturally at their current state, but need a little “help” to become infected. From this set, a third set of non-infected nodes is constructed; denoted by {S2}. This set consists of nodes that are not infected, but if seeded they would infect nodes in S1 naturally. From this set the algorithm chooses nodes that would influence the larder number of nodes in S1.

If no such node exists, the algorithm changes the tactics and “jumps” into a new cluster, thus in this case it searches for nodes with the highest potential without inspecting the social impact. This is performed again by computing the eigenvalue of each node while reducing the network to only include the non-infected nodes.

As long as the network is not highly clustered, the jumps to new clusters are not required. Nonetheless, when the network becomes highly clustered, it might sometimes become “short sighted” regarding the future potential value of the nodes which are planned to be seeded. For example, some nodes might receive a high-local score within their cluster but since the cluster is already saturated, i.e. most nodes in the cluster have already adopted the new idea, it is better to seed or plan the infection of nodes which are less valuable from an ‘entire-network’ prospective than to invest in seeding these locally attractive nodes. Such cases are common when the selected nodes bridge a saturated cluster to new unsaturated clusters. This problem required the development through the Scheduled_Clustering algorithm as described below.

The pseudo-code for the Scheduled_Clustering.

Algorithm 2:
SCHEDULED_SOCIAL
seeding
/* Seed T nodes with highest Eigenvalues */
Initial seeding (S0);
Time:= Time ++;
For all Non-Infected nodes:
Define list S1¹
For all i nodes in S1:
Add neighbors of i to S2²;
Seed node that repeat most in S2;
If no node repeat >= (B-1) times:
Jump to new cluster³;
Perform natural evolution step;
While (budget > 0) return to step of “For all Non-Infected nodes”

Remarks for the algorithm:

First remark—Neighbors of S0 that will become infected if one more neighbor is infected; Unique=No repetition.

Second remark—Neighbors of Neighbors with repetition. The algorithm may be executed in a recursive manner thereby scanning higher degrees of neighbors—for example neighbors of neighbors of neighbors (third degree neighbors) and then at the next iteration fourth degree neighbors . . . and the like.

Third remark—Jumping to a new cluster is performed by determining the number of non-infected three-hops-neighbors, i.e., “Friends of Friends of Friends” in potential clusters. It is only performed in the SCHDULED_CLUSTERING method. In several experiments, this measure has been found to perform almost equivalently to the eigenvector centrality, yet, it offers a procedure which is much more efficient.

Fourth remark—more advanced algorithms can take into consideration the Oblivion state of nodes (i.e. when will they stop being infectious). Furthermore, such algorithms can also take into account cases in which nodes rejected seeding attempts (and therefore should not be seeded again in the near future).

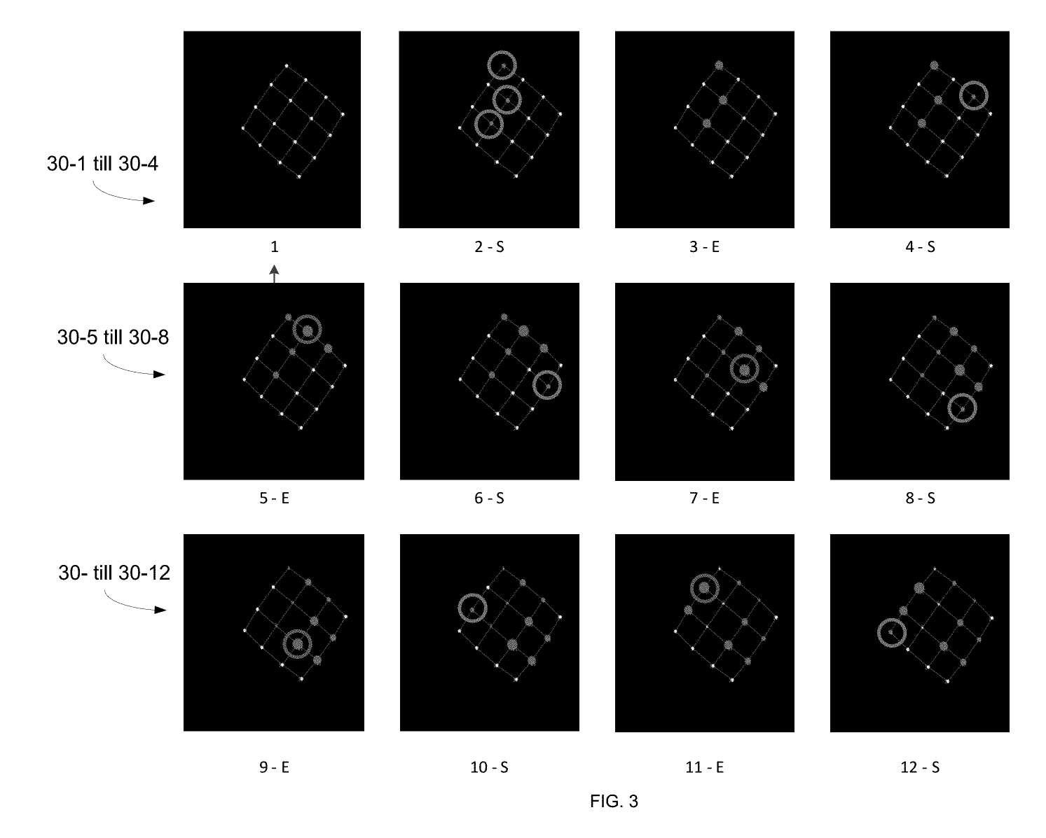

FIG. 3 below, present the Scheduled_Clustering on a 4 by 4 mesh network according to an embodiment of the invention. Images 30-1, 30-2, 30-3, 30-4, 30-5, 30-6, 30-7, 30-8, 30-9, 30-10, 30-11 and 30-12 illustrate the state of the mesh during twelve consecutive points in time.

The thick circles represent seeding, while the blue circles represent natural infections. The size of the infected node represents the time left until an infected node becomes non-infectious. It can be seen (in frames 30-1 till 30-5 (denoted by S) that at the beginning the algorithm seeds nodes without any natural infections, but that then, a natural evolution of infection occurs at frame 30-6 (denoted by E), followed by a seeding at frame 30-7, another natural infection at frame 30-8, etc. . . .

In FIG. 3, a simple mesh of 4×4 is presented, with each frame representing a new time frame. A green circle denotes an act of seeding on the selected node, and a circle denotes a node that was virally infected (i.e. without intervention). The viral rule is such that a node needs 3 (i.e. a fixed threshold set to 3 in this case) neighbors to adopt an idea in order for the node itself to viraly adopt it too. In frames 1-4, the acts of seedings are executed. First, when no node has already adopt the idea, 3 nodes which are highly connected are chosen (see frame 30-2). This does not yield any result (see 30-3). Then at 30-4 a fourth node is seeded, but now through the scheduling method. This seed creates a viral infection (30-5). Now, the algorithm searches for nodes that if seeded, they would create the maximal number of viral infections in the next time frame. In 30-6, such a seed is executed, followed by a viral infection in 30-7. Next, in 30-8, a node is seeded, such that it will infect viraly a node in 30-9. Similar steps are executed in 30-10, 30-11, 30-12, etc.;

Results for Scheduled_Clustering

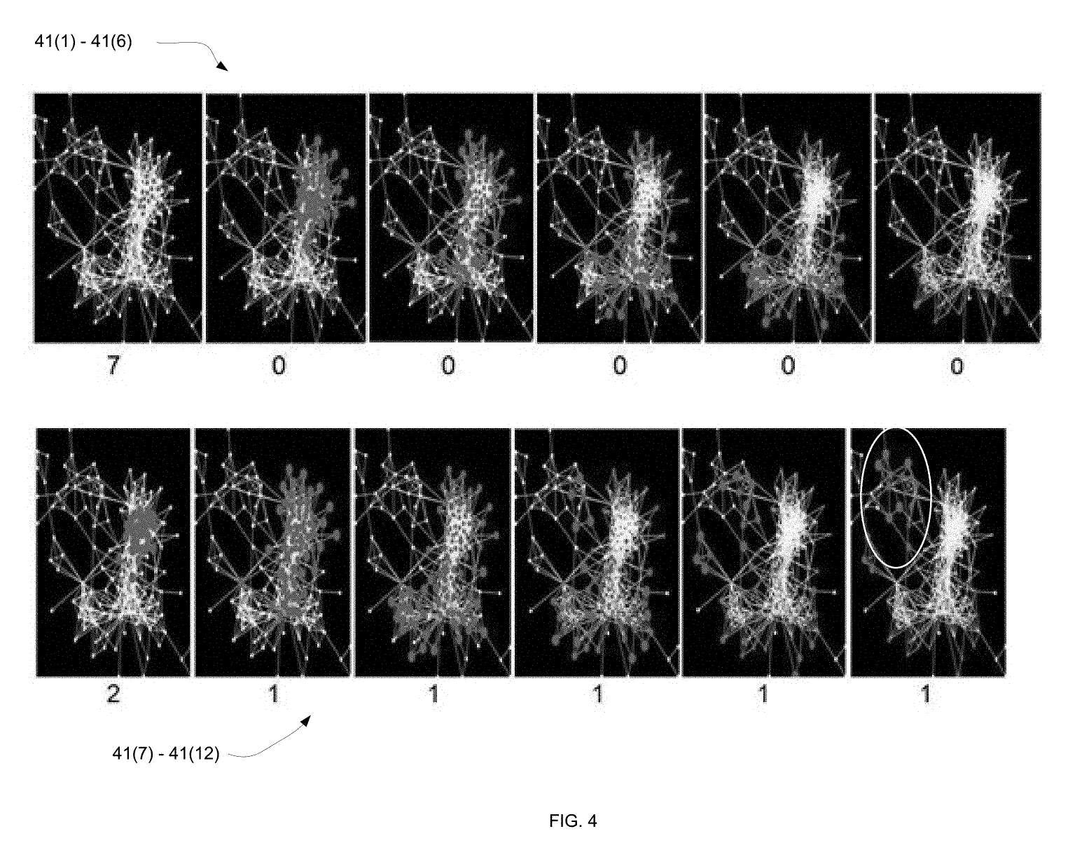

The results of executing the Scheduled_Clustering heuristic are shown in FIG. 4(a) along with the results of the Initial_Eigenvector_Seeding (seeding at t=0 B nodes with the highest Eigenvalues). As shown in FIG. 4 (top sequence of images 40(1)-40(6) and bottom sequence of images 40(7)-40(12)), the Scheduled_Clustering heuristic infected 93% of the nodes, compared to the Initial_Eigenvector_Seeding approach that infected 74% of the nodes. As shown in FIG. 4, the reasons for the superiority of this heuristic, is its ability to “jump” to a new cluster when the existing cluster becomes saturated.

FIG. 4 illustrates Seeding by Initial_Eigenvector_Seeding (upper) vs. Scheduled_Clustering (lower) according to an embodiment of the invention. B=7, and C=3. It can be seen that while both methods spread through the large cluster, only the Scheduled_Clustering succeeds to spread into the upper cluster.

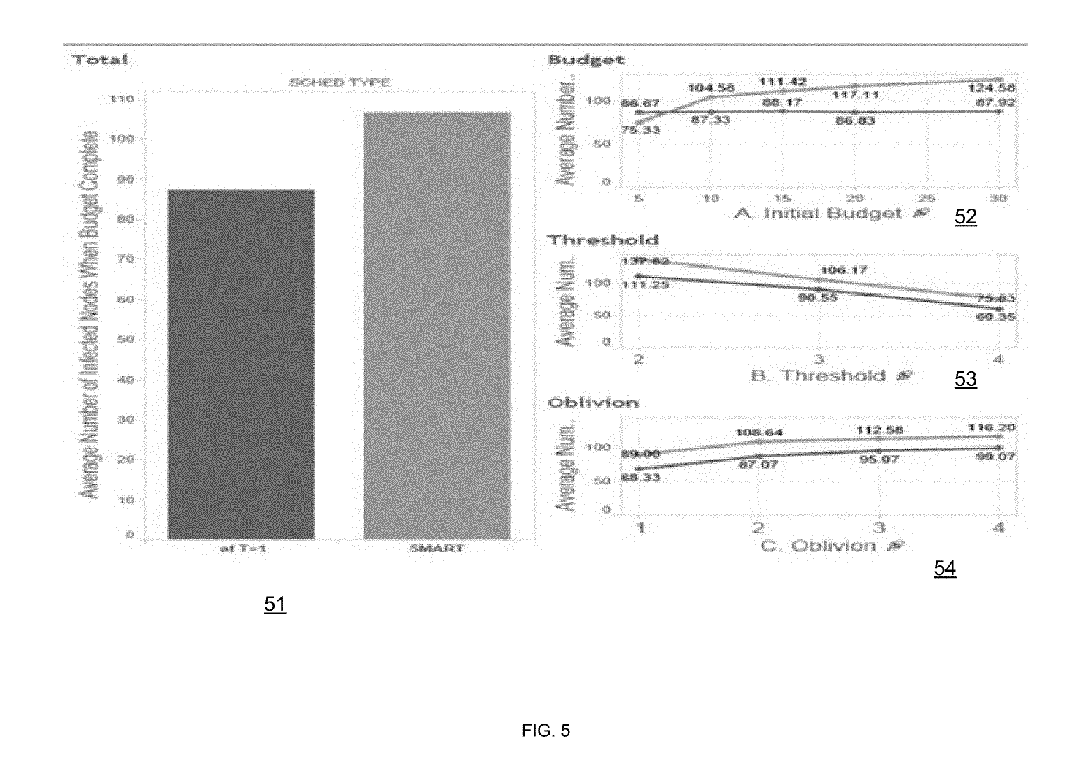

The algorithm was run over 256 executions with different networks and different initial conditions, while using the Scheduled_Clustering and the Initial_Eigenvector_Seeding heuristics presented in FIG. 5. It can be seen that the Scheduled_Clustering method (left bar) outperform on average the Initial_Eigenvector_Seeding method by approx. 22%.

FIG. 5 illustrates the average final number of infected nodes by the Scheduled_Clustering heuristic (right bar in graph 51) and the Initial_Eigenvector_Seeding heuristic (left bar in graph 51) in 256 executions according to an embodiment of the invention. Influence of the maximal budget B (graph 52); infection threshold C (graph 53); and infection time Oblivious (graph 54) on the final average number of infected nodes is seen in all levels, excluding in extremely low budget in which the seeding does not occur

These results were consistent on several different network topologies include a sample of Facebook users, Dolphins social communication network, Jazz musician network, a Political Blogosphere and a part of the 2011 social protest network in Israel.

The SCHEDULING_SOCIAL method

The scheduled_social seeding method prioritizes the seed trials by computing the score of the related nodes at each step. The score is based on the expected value for each potentially seeded node. It reflects the probability of a successful seeding of the node, p(ψ), multiplied by the utility U (ψ) for such an event, taking into consideration the potential effect of the node on future seeding attempts through its neighbors.

The probability of a successful seeding of the node may be updated in any manner, in response to any information related to a user represented by the node.

The information may be social network information or external information (that may differ from social network information). For example—previous purchase, socio demographic status, background information, any available information about the user.

The utility function of node v is evaluated by considering two terms. First, the successful seeding of the node increases the utility value by one, reflecting the additional infected node. The second term reflects the utility gain due to the increased probabilities of future successful seedings of the uninfected neighbors of v. In other words, if v will be infected, its neighbors will have higher success probabilities. The increased utility value due to the uninfected neighbors of v is computed by calculating the sum of probability changes over all nodes uεNᵥ⁻, where Nᵥ⁻ denotes the non-infected neighbors of v. Assuming that a successful seeding event occurs, this second term reflects the expected value change of nodes Nᵥ⁻:ψ with respect to their current value Nᵥ⁻:ψ̅. More formally, U(v)=Σ_{uεN}_{ᵥ}_{^{−}}p(ψ)·U(ψ)−Σ_{uεN}_{ᵥ}_{^{−}}p(ψ̅)·U(ψ̅), where ψ denotes the states of the neighboring nodes uεNᵥ⁻ following a successful seeding of v, while ψ̅ denotes the states of the neighboring nodes before the seeding of v. Note that this formulation is recursive since U(ψ̅) is unknown and has to be calculated as well.

The recursive computation method used to calculate the score, when executed for a depth of three recursion levels, is seen in following equation. The recursive computation of the score, for a depth of k iterations, is shown in the Scheduled social scoring algorithm below and called the seeding strategy “Social_<k>”, i.e., “Social_0”, “Social_1” and “Social_2”, where Social_0 computes the score simply as the term p(v); Social_1 as p(v)·{1+Σ_{uεN}_{^{−}}₍ᵥ₎[p(u)]}; and Social_2 as the full equation shown in following equation:

Score(v)=p(v)·{1+Σ_{uεN}_{^{−}}₍ᵥ₎[p(u)·(1+Σ_{wεN}_{^{−}}₍ᵤ₎p(w))]}

More specifically, the score is computed recursively, as defined in the pseudo-code of the scoring algorithm below.

The Scheduled Social Scoring Algorithm

```
  Function Social Score(v, G, k):
  # input: v - relevant node, G - Graph, k - Levels
  (Social_0, Social_l, Social_2)
    $Set p ( v ) = {p}_{{Max}_{v}} ( \frac{min ( {θ}_{v} , \vert {N}_{v}^{+} \vert )}{{θ}_{v}} )$
# Probability of infection of v in current time step
if Levels = 0:
return p(v) # Level 0 - Greedy score
else:
set Score = 1
for u in N⁻(v) # go over all non-infected neighbors of v
score = score + Social(u, G, Levels - 1)
return p(v) * Score
```

To further clarify the above recursive method, note that the expected value of v itself is p(v) and that the expected value of uεNᵥ⁻ is p(v)·p(u|v)=p(u,v), implying the occurrence of both events, i.e., the successful infection of v followed by a conditioned infection of u. Similarly, the expected value of w (where w is in the 2^{nd} neighbors' circle and u is in the 1^{st} neighbors' circle, is p(v)·p(u|v)·p(w|u,v)=p(u,v,w), as seen in equation.

Discussion

The two presented algorithms (termed as “suggested method”) improve the spread of information through social networks. Although optimal solutions for similar scheduling methods exist in Operational Research literature, they are known as NP-hard, and as such simple heuristics should be developed.

The suggested method is a greedy heuristic which plans for the short term, nevertheless, it is found beneficial.

The suggested method assumes that the social graph is provided. This assumption is theoretical to an extent, since the social network graph is a valuable commercial asset is not readily available and is heavily protected by social networks sites (such as Facebook). Crawling social networks sites poses technological, ethical and legal challenges.

The algorithm can be used as part of a recommendation system supporting sales departments, by pinpointing which customer to address at a given time, in such a way that would incite a viral process.

Increasing sales through viral methods requires selling in an environment that is already somewhat familiar with the new product/service. Since the very basic essence of viral methods is based on a friend's recommendation, if the new product/service was not adopted by any friend, accomplishing a sale would require more effort from the salesperson. This is why the start of the viral sales is harder, since the number of adopters is low. On the other hand, in some cases, when everyone has already adopted the product/services, finding a new potential client is also hard since new potential buyers are scarce. In these cases, the Scheduled_Clustering algorithm would recommend to “jump” into a new territory whereby the cost effectiveness of the sales efforts is increased.

The spread of information is an important area of research for many industries. People are more likely to adopt information arriving from few independent sources over receiving it from a single source. We claim that the arrival times for the messages, as well as their source are critical for forming an opinion and creating influence, specifically when taking into account that we are living in a word where information flow grows rapidly.

Since most messages compete in a world bombarded with information, a time window too wide between messages would decrease the probability of spread (since the message would be forgotten). From the other hand, a time window too narrow, would not allow other users to spread the message further on and again, would decrease the spread.

The tendencies to follow the opinions (messages) of others should therefore be addressed along the tendency to forget old news (messages), and these two require the Scheduled Seeding policy since spread can only occur in a defined time.

While a success of any viral process is highly dependent on its initial conditions, seeding at these early stages has a major impact on the spread later on. Nevertheless, we have shown that correct timing of seeding efforts by the Scheduled Seeding method can outperform a method of seeding (allocating) the entire budget into the most promising nodes at the beginning of the process. Furthermore, in many cases the marketing/sales department is limited in the number of seeding it can do in a day. Sales and marketing teams are of limited sizes, and their working efforts can only prolonged over a fixed working hours and workers. The seeding policy described above seems to be valuable not only as a new theoretical paradigm, but also as a practical recommendation system that would help the sales workers.

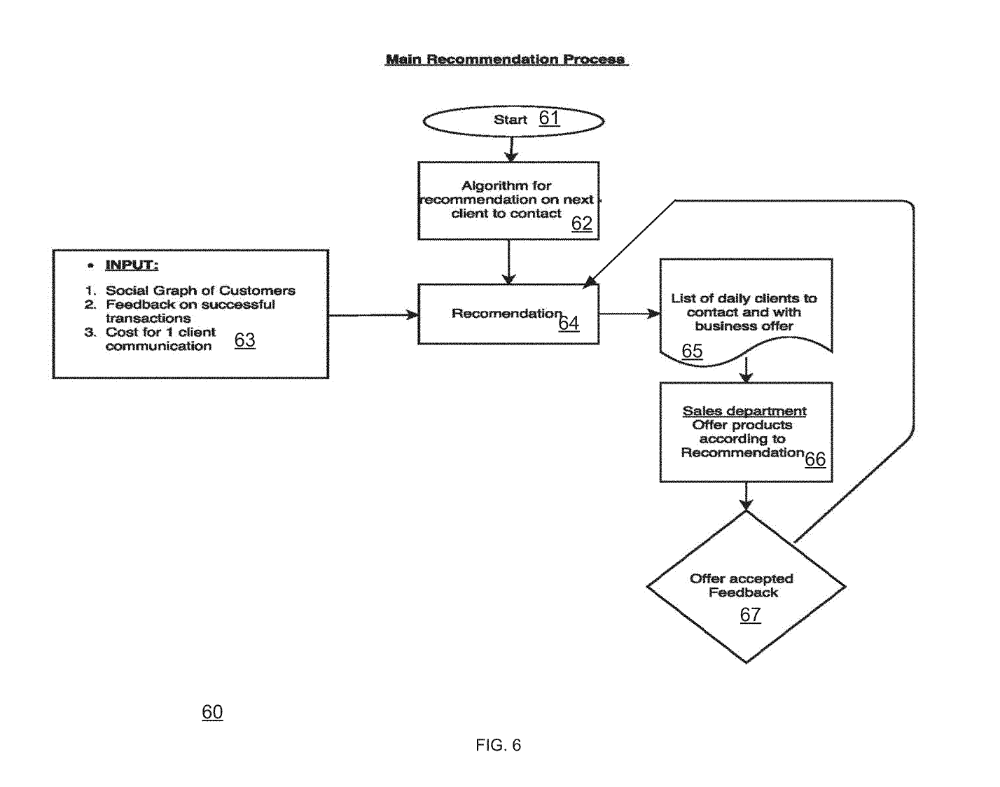

FIG. 6 illustrates method 60 according to an embodiment of the invention.

Method 60 starts by start step 61.

Start step 61 may be followed by step 62 and 63.

Step 62 may include receiving or calculating an algorithm for recommendation of the next client to contact (next member of receive information).

Step 63 may include receiving various inputs such as social graph of customers, feedback on successful transactions and cost for communication to a client.

Step 62 and step 63 (or receiving various inputs) are followed by step 64 of applying the algorithm on the inputs to recommend which client to contact (next member of receive information).

Step 64 may be followed by step 65 of generating a list of clients to contact and offer business.

Step 65 may be followed by step 66 of offering products to the clients according to the recommendation.

Step 66 may be followed by step 67 of receiving feedback about acceptance of offer. Step 67 may be followed by step 64.

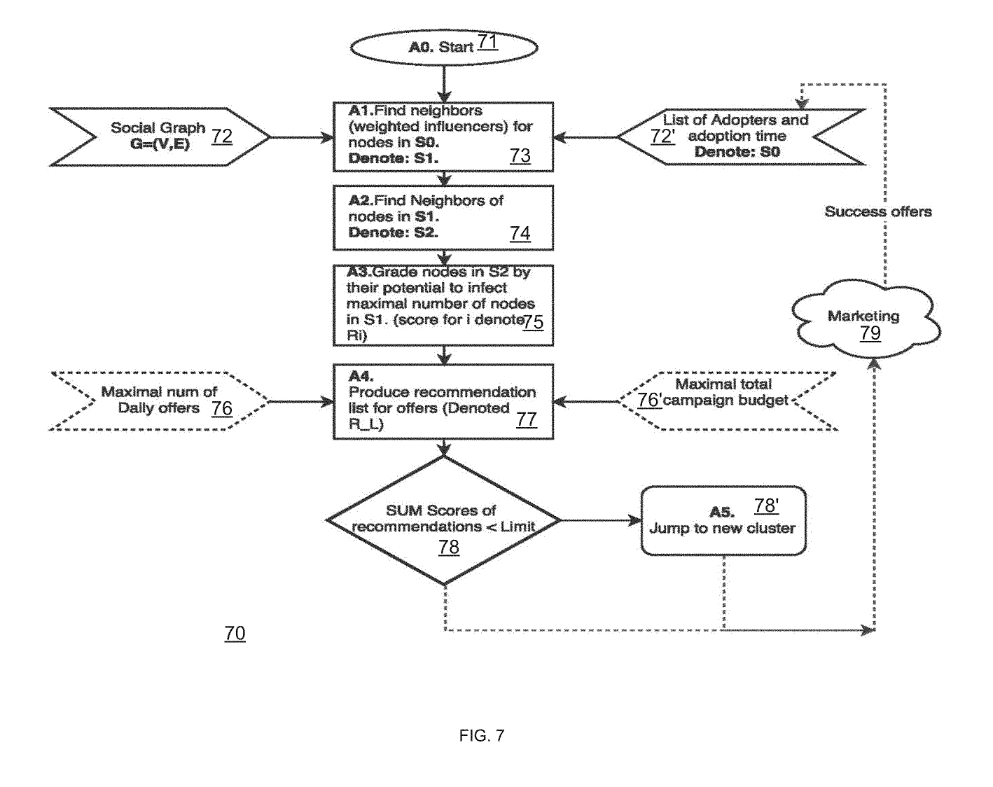

FIG. 7 illustrates method 70 according to an embodiment of the invention.

Method 70 starts by start step 71 (A0).

Start step 71 may be followed by step 73.

Step 73 may also be preceded by step 72 receiving a social graph G=(V,E) and step 72′ of receiving list of adapters (infected members—denoted S0) and adoption time (infection time).

Step 73 (A1) may include finding neighbors (S1) for nodes in S0.

Step 73 may be followed by step 74 (A2) of finding neighbors (S2) for nodes in S1.

Step 74 may be followed by step 75 (A3) of grading nodes in S2 by their potential to infect a maximal number of nodes in S1. The grade of an i'th node is denoted Ri.

Step 75 may be followed by step 77 (A4) of producing a recommended list for offers (which clients to contact-which members to infect).

Step 77 may be preceded by receiving budget constraints—for example—step 77 may be preceded by step 76 of receiving a maximal number of daily offers and may be preceded by step 76′ of receiving a maximal total campaign budget.

Step 77 may be followed by step 78 of calculating a sum of scores of recommendations and check if it exceeds a limit—if so jumping to step 78′ of jumping to a new cluster (selecting clients from another cluster during the next iteration of step 73). If no—jumping to step 79 of marketing and step 72′.

Step 78′ is also followed by step 79.

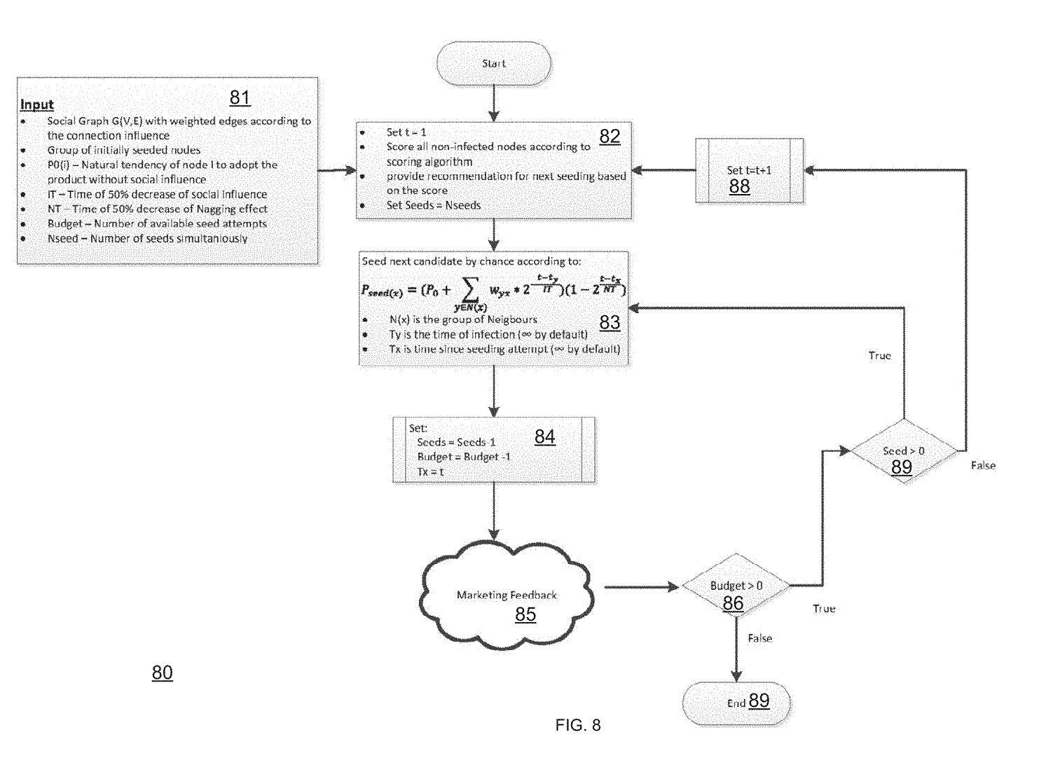

FIG. 8 illustrates method 80 according to an embodiment of the invention. Method 80 may be executed by a computer that has one or more hardware processors, one or more memory modules, hardware interfaces for exchanging information, and the like.

FIG. 8 illustrates the probabilistic model.

Method 80 starts by step 81 of receiving (by a hardware communication interface such as a wired and/or a wired communication interface) as input (i) a social graph G(V,E) that may include weighted edges according to the connection influence between one member of a social network to another, (ii) a group of initially seeded nodes (corresponding to the first point in time out of multiple points in time), (iii) PD(i)—the natural tendency of the i'th node to adapt a produce without social influence, (iv) IT—the time of 50% decrease of social influence, (v) NT—the time of 50% decrease of nagging effect, (vi) budget—the number of available seed effects, and (vii) Nseed—the number of seeds that can be infected simultaneously.

The connection influence refers to the probability of an infection of a non-infected member as a result of an infection (while contagious) of a neighbor member.

Step 81 is followed by step 82. During a first execution of step 82 a variable t is set to one. Step 82 also includes scoring all non-infected nodes according to a scoring algorithm, providing a recommendation for next seeding based on the score and set Seeds=Nseed.

Step 82 may be followed by step 83 of selecting (by a seed candidate selection module that may include hardware circuitry such as a hardware processor and/or a hardware accelerator that is configured to executed instructions stored in an instruction memory) next seed candidates by a seeding probability.

Step 82 may include calculating the following equation:

$${P}_{seed ( x )} = ( {P}_{O} + {\sum }_{y = N ( x )} {W}_{xy} * {2}^{\frac{t - {t}_{y}}{IT}} * ( 1 - {2}^{\frac{t - {t}_{x}}{NT}} )$$

Wherein x denotes the evaluated node, N(x) is the neighbors of the node and include neighbors y, W_{xy} is the connection influence between nodes x and y, t_{y} is the time of infection of neighbor y, tₓ is the time since a seeding attempt (infection attempt). The default for tₓ and t_{y} is infinity.

Step 83 is followed by step 82 of incrementing Seeds (by one) and reducing the Budget (by a budget and flow manager that may include hardware circuitry such as a hardware processor and/or a hardware accelerator that is configured to executed instructions stored in an instruction memory) by the cost of the sending of information (for example decreasing Budget by one), and setting tₓ to t (as the node was infected).

Step 84 may be followed by step 85 of receiving a marketing feedback (by a feedback interface).

Step 85 may be followed by step 86 of checking (by the budget and flow manager) if the budget was not fully used (Budget>0) if so—the method proceeds to step 89. If the budget was fully used the method ends (step 89).

Step 89 includes checking if Seed exceeds zero. If Seed exceed zero—jumping to step 89. If Seed=0 then jumping to step 88 of increasing t and jumping to step 82. Else-jumping to step 83.

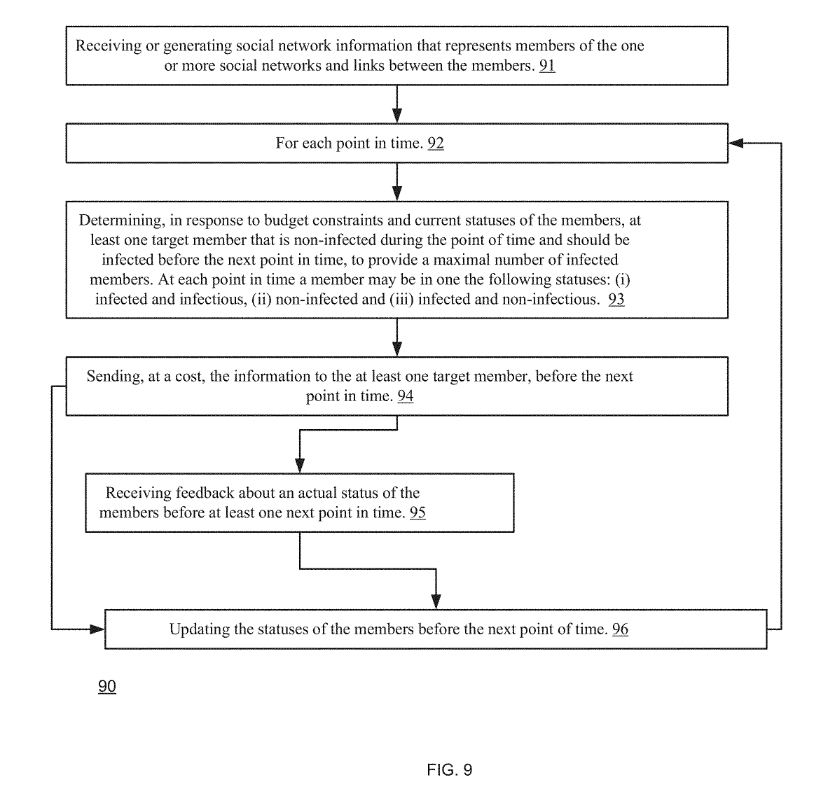

FIG. 9 illustrates method 90 for information spread in one or more social networks, according to an embodiment of the invention.

Method 90 may start by step 91 of receiving or generating social network information that represents members of the one or more social networks and links between the members. A first member is linked to a second member when the first member can send information, via a social network, to the second member.

The social network information may be social network graph and wherein the members are nodes of the social network graph. Other representations of the social network information may be provided.

Step 91 is followed by multiple repetitions (for each point in time of multiple points in time) of various steps. The repetition is represented by step 92 (for each point in time).

The various steps start by step 93 of determining, in response to budget constraints and current statuses of the members, at least one target member that is non-infected during the point of time and should be infected before the next point in time, to provide a maximal number of infected members.

At each point in time a member may be in one the following statuses: (i) infected and infectious, (ii) non-infected and (iii) infected and non-infectious. It may be assumed that a member may be infectious for a certain period of time—so that the status of a member that is infected and infectious may turn, after the certain period of time, to infected and non-infectious.

The certain point of time may be determined based on the event that is associated with the distributed information. The certain period of time may be determined based on the heard behavior.

The social network information may be a social network graph and the members are nodes of the social network graph. The nodes may be arranged in clusters. Step 93 may be responsive to the clusters. For example—step 93 may determine to jump to a new cluster—and select one or more target members outside of a current cluster.

Step 93 may be followed by step 94 of sending, at a cost, the information to the at least one target member, before the next point in time.

The sending of the information may result in one or more infection attempts.

The cost may be reduced from a budget. The budget may be one of the budget constraints.

Step 94 may be followed by step 96. Step 94 may also be followed by step 95.

Step 96 may include of updating the statuses of the members before the next point of time. The updated statuses may reflect, during the next iteration of steps 93-95 the current statuses of the members.

Step 95 may be includes receiving feedback about an actual status of the members before at least one next point in time. Step 95 may be followed by step 96 and step 96 may include updating of the statuses in response to the feedback.

Step 96 may be responsive to an estimated relationship between infection attempts and infection success.

Step 96 may be based on a deterministic model of a relationship between infection attempts and infection success.

The deterministic model of the relationship between infection attempts and infection success may dictate that a non-infected member becomes infected once a predefined number of neighbor members of the non-infected member are infected and infectious.

Step 96 may be based on a probabilistic model of a relationship between infection attempts and infection success.

The probabilistic model of the relationship between infection attempts and infection success may dictate that a probability of non-infected member to be infected increases with an increment of a number of neighbor members of the non-infected member that are infected and infectious.

Step 96 may be followed by step 92 (until exhausting the multiple points in time).

Method 90 may include receiving external information about a given member and calculating a probability of a successful seeding related to the given member.

The determining of the at least one target member is responsive to the probability of the successful seeding related to the given member.

External information may differ from the social network information. Non-limiting examples of external information may include sociodemographic information, information about previous purchases, credit score information, internet cookies information.

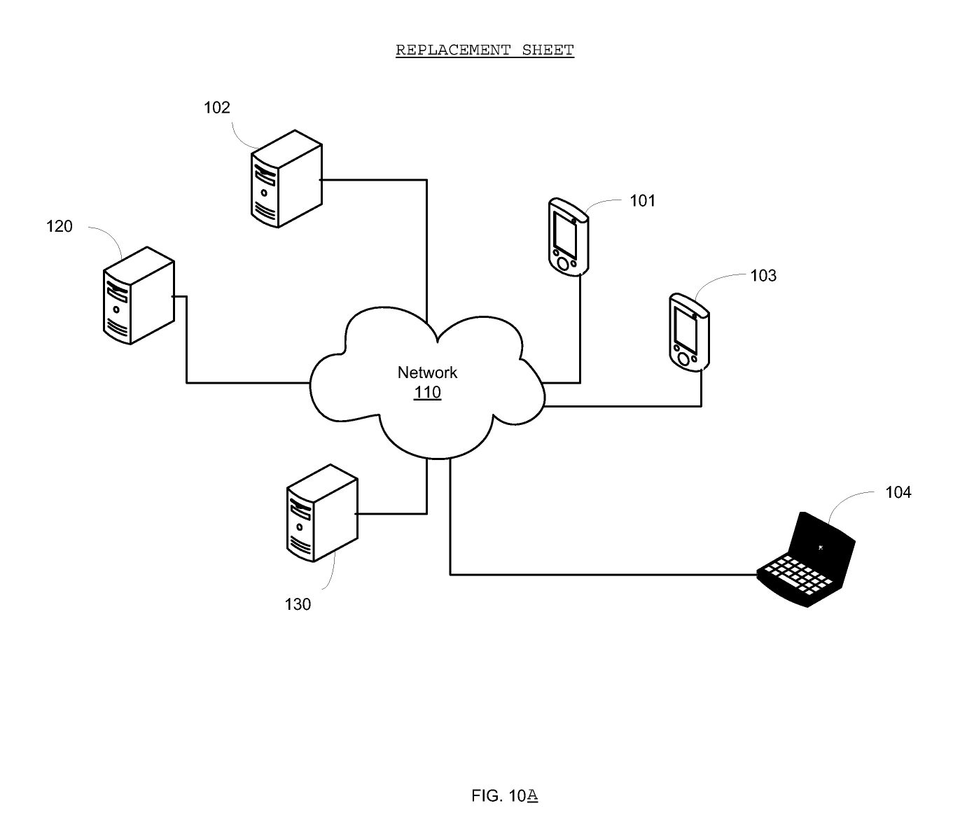

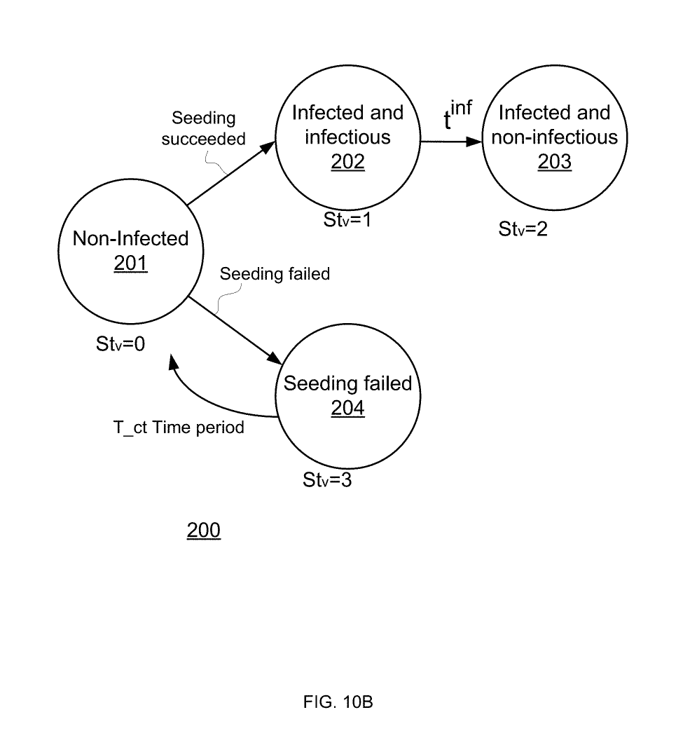

FIG. 10A illustrates network 110 that is coupled to computers such as servers 102, 120, 130, laptop 104 and smartphones 101 and 103.

Server 120 may execute any of the methods illustrated in the specification. Other computers may belong to members of social networks.

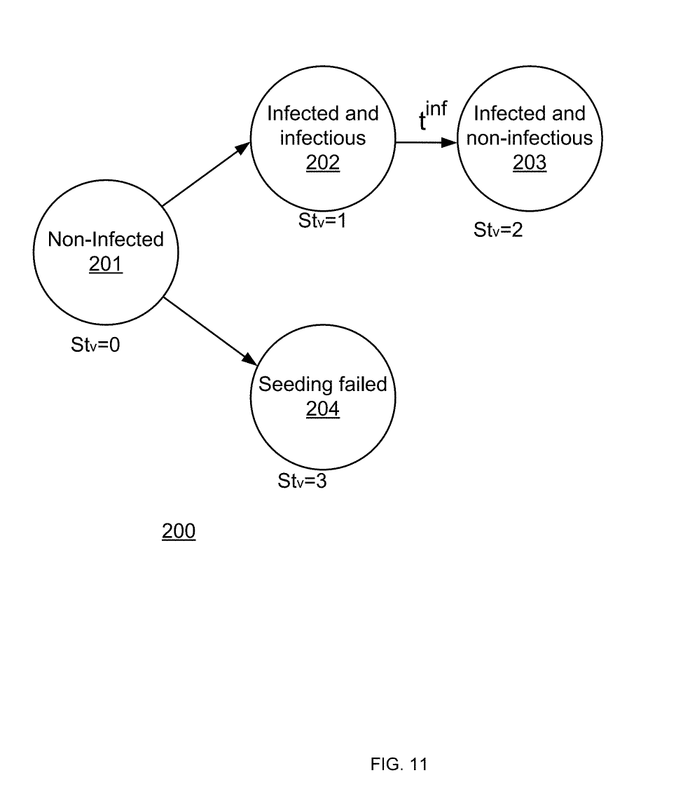

Server 120 may apply the state machine of FIGS. 10B and 11.

The state machine may transient between non-infected state 201, infected and infectious state 202, infected and non-infectious state 203 and seeding failed state 204. The seeding failed state 204 may be followed by state 201 after a predefined “cooling” period (T_ct).

State 201 may be followed by state 202 if the seeding succeeded and by state 204 if the seeding failed. State 202 may be followed by stets 203 after t^{inf} period.

The success of the seeding may evaluated under the following assumptions: 1. seeding can be accepted or rejected by a stochastic probabilistic way by a user.

In order to schedule the acts of seeding the probability of a successful seed (i.e. a client accepts the offer is

$${p}_{v} = {p}_{max} * ( \frac{min ( θ , \vert {N}_{v}^{( + )} )}{θ} * {S}_{NS} + ( 1 - {S}_{NS} ) * U ) ,$$

where pᵥ is the probability of acceptance, θ is a threshold which determines the number of friends (neighbors) that actually influence the node, |Nᵥ⁽⁺⁾| is the number of infected neighbors, S_{NS}, is the part of the purchase (seed acceptance) probability which is actually influenced from the social factor, U is a random number 0-1, and pₘₐₓ is the maximal probability of acceptance (even if all the node's friends have accepted.).

In the model as described above it is preferable (but not a requirement) that an initial set of connected nodes of size |F^{init}|=Mₛ^{init}*m, where m is the network size G=(V,E), |V|=m, and Mₛ^{init}ε(0,1) are first seeded with p=1, and only then the scheduling seeding algorithm starts.

The seeding decision is to k nodes with the highest “attractiveness score” with the k nodes of the highest scores being seeded, at each period of time, i.e. day.

The “attractiveness score”, i.e. how attractive is the node for seeding is computed by SCᵥ=[Σ_{uεN}_{ᵥ}_{^{−}}(pᵤ*|Nᵤ⁻|+(1−pᵤ)*|Nᵤ⁻|*ln(t^{ct}))+pᵥ where SCᵥ is the attractiveness score, Nᵤ⁻ are the set of non-infected neighbors of u, and t^{ct} is a time defined by the seeding company, by which it should not contact a customer with an offer after he/she have refused a previous similar offer (i.e. cooling time).

Latent Viral Marketing, Concepts and Control Methods

The following section would describe an additional model and mode of operation that might be applied in cases where an active viral process is scarce, but a latent viral process still exists as would be described below.

Generally, it is believed that information spread follow the Linear Threshold Model. According to this model, first, the spreader selects several chosen nodes and seeds them (where the act of a seeding, reflects an intentional infection of nodes). Then, a viral process begins, where the information spreads through the nodes of the social network and users infect each other's. Such an act of infection, can be performed for example, if a user writes on his Facebook wall a new message, which is later seen by the user's friends. Then, the user's friends can chose to send this message to their own friends. In each step. A user can alternatively send the message directly to a single friend or send it to a group of friends. In Twitter, the user spreads a message by Retweeting a received message, or simply by twitting a new tweet that contains a relevant link. The follower of the user would then have this message presented in their tweets time line, and can open the link. If they find the message interesting, they can retweet it, thus the message will appear on the time line of their followers.

The spreading methods mentioned above are all active viral methods. This implies that users should perform an action (such as a retweet or post on a wall) in order to spread the message to another. In each step, users invest an effort (i.e. “work”) toward spreading the message. Such a method of information sharing is desirable to many commercial firms. These firms seek to harness the viral forces of these many “free spreaders” and have these spreaders invest their effort to spread the commercial firm's products or services. The firms wish to gain an almost unlimited source of free workers that spread their product or services.

Unfortunately, very few products spread solely by viral forces, and most firms still need to employ efforts, e.g. by sales and marketing departments, to promote their products and services.

The low ability spread products and services by viral mechanisms is not due to the low importance of social forces in the act of purchasing. In fact, one's social connections are known for many years to have an immense influence on one's personal decisions making. The first social psychologists, Asch, Milgram, Granovetter and Zimbardo, revealed the importance of social influence as a key factor influencing one's attitudes and values. Social proximity in a social network predict tendencies that were believed to be genetic. For example, the tendency for obesity, smoking, or even the tendency of being happy. If such internal traits spread through the links of the social network, shouldn't we expect that recommendation for a new products would spread as well?

In practice, encouraging customers to invest efforts to spread a commercial product is not always as easy as it seems. First, it is required that these customers would like the product. This is a critical requirement in any effort for successful viral marketing. This is true, since an influential customer, which actually dislikes the product, will influence the spread in a negatively. Furthermore, customers do not usually like to promote commercial firms by their own good will.

A few relatively recent works (also see section have shown that the tendency that a customer will spread commercial products is lower than previously believed. These works observed the lengths of information cascades in large data sets and found them rather short and shallow. It seems as the vast majority of messages never spread through thousands of users, but rather through a relatively small number of users. Since large information cascades are rare, it is also rare that a product or service spread solely by viral forces. An external aid to spread is usually required for most products or services

This part thus provides a model of information spread, which considers social influence in a more realistic way. The method recognizes the importance of social forces, but does not expect to gain “free workers” from it. An expectation to have a customer actively spreading a commercial product or services is not too realistic. The customers influence on his friends is important, but the influence is not sufficient and is not active, it is hidden, and latent.

As a motivating example, let us consider a setting in which a given company aims to promote the sales of one of its products. The company's sales representatives contact customers and offer them to purchase the product by phone, or use an equivalent advertising platform. If a customer purchases the product, he/she might tell some of his/her friends (network neighbors) about this purchase. We assume that these friends will not actively contact the company to purchase the product by themselves, but would rather keep the positive recommendation latent in their minds.

However, if contacted by the company's sales representatives within a certain period from the initial recommendation, the positive recommendations accumulated on the product, as provided to them by their friends, is likely to influence their likelihood to purchase the product. If the sales representative address the customer long after the customer's friends' recommendations have been heard, the customer is less likely to adopt or purchase the offer product or service. The company thus needs to decide which users to approach and at what points in time in order to utilize its sales budget in an efficient manner, while taking into account the latent influence; e.g. the effect of the user's friends recommendations as is accumulated in the customer's minds.

This work fits the scenarios above. We define the Latent Viral Marketing Model (LVM), and a related seeding method, the Scheduling Seeding Heuristics (SSH), which increases the number of successful seeding attempts in the above scenario. The work adds a stochastic aspect to the deterministic Scheduled Seeding and Scheduling Clustering methods and adds the realistic latency According to a large set of simulations, SSH significantly improves the number of successful seeding attempts in scenarios similar to the LVM model described above, in comparison to existing state-of-the-art seeding benchmark approaches.

These benchmark approaches mainly focus on careful selection of nodes with high centrality measure, such as PageRank, Eigenvector Centrality, or simply the node's Degree Rank in the initial seeding process.

More specifically, the SSH reaches an average improvement rate of 23%-153% in the number successful seeding attempts (depending on initial conditions), and in some extreme cases reaches an improvement of up to 10 folds.

The next section includes a brief background on information diffusion models through social networks and in particularly, on the Linear Threshold model. The background section is followed by an in-depth description of the proposed LVM information spread model followed by the SSH seed selection heuristics.

It presents the results of various simulations experiments and summarize the study by a concluding paragraph The Linear Threshold Model

One of the most popular models in the field of viral marketing is the Linear Threshold model. This model starts when an initial set of nodes is first infected, followed by a viral process model which simplifies social influence. According to the Linear Threshold model, the viral spread will flow if Σ_{wεW}_{ᵥ}b_{v,w}≧θᵥ, where Wᵥ denotes the set of infected neighbors of v, and b_{v,w} denote the weights; i.e. the social influence that w activates on v. If the total influence reaches a threshold θᵥ, node v changes its state and becomes infected.

Plotting the total number of infected nodes versus the elapsed time, while applying the Linear Threshold viral process, creates a plot that often resembles a sigmoid function. The number of infected nodes slowly increases at the beginning of the process, then after enough infected nodes accumulate; it increases sharply, up to the point where most nodes are infected. Then, when additional uninfected node becomes scarce, the speed of infection slows down, and the slope decreases.

Similar sigmoid spreading curves represent many physical phenomena of spreads, such as for example a forest fire or virus epidemic. In a forest fire, after an intentional ignite (i.e. seeding) the fire spread is first slow. Then, as the fire grows, it quickly spreads further by its own forces to the rest of the forest. In this period, in many cases, the fire can burn large parts of the forest in a short period. At the end, when much of the forest is already burn, the fire slowly decays since unburnt trees are infrequent, until it completely decays.

This sigmoid growth function, while fitting numerous natural spreading phenomena, does not seem to fit the spread of ideas through social networks.

Growth of Actual Information Cascades

A growing body of works which analyzed several large social networks data sets, claim that large information cascades are rater rare (also see [00199]). Most information cascades only spread through two people, even fewer spread to three. For example, a spread of a message to five friends occurs in only ⅛ of the messages, and a spread of a message 3 times in a vertical cascade (i.e. an initial message that is spread to a friend, and this friend spreads it again to his/her friends), only occurs in 1/16 of the messages. An even larger spread, for example a vertical spread of 8 steps, was found to only occur in between 0.01%-0.001% of the messages. These studies were replicated over different social networks; and capture an important aspect of information cascades. While people collect information consistently, they do not always actively diffuse it further to their friends.

Information cascades differ from the spread of biological virus in their selective nature. While collecting the information might be similar to receiving a virus, and people do collect much of the information they receive, information spread is more selective. People tend to distribute information cautiously and not repeat everything that they have heard to everyone.

This is one of the reasons, why it is rather rare that a company succeeds to distribute its products with no additional effort, simply by using a viral process. In contrast to a virally based strategy, most companies need to spend a lot of effort (and budget) to actively help the spread of their products. Most companies need to construct brands names through commercial communication methods, they employ sales personnel, and they actively promote social network marketing strategy. The conventional Linear Threshold model does not address the every day's scenario, in which a company invests substantial effort to promote a product or a service. This is why the LVM model can be valuable as defined below.

Assumptions Underlying the Latent Viral Marketing Model

The first works on information spreading through social networks compared the spread phenomena to the spread of viruses. The SIR model is the basic model of virus spread. Unlike the spread of a biological virus, social norms influence the adoption of ideas. The rate of acceptance of a certain idea in one's social circle predicts the likelihood for adopting it. Social norms are indeed integrated in the Linear Threshold model, which defines the probability of infection as the sum of intentioned neighbors' weights. Although the theoretical importance of this work, along similar information cascades works is evident, these works does not fit a case of commercial products or services in which the spread requires continues effort of marketing and sales departments.

In order to fit the Linear Threshold model to these scenarios, we should first change the deterministic nature of the model. Another required modification is the clear separation between the seeding stage and the viral stage, which does not fit the reality of a commercial product spread. The investment of an entire budget in a single and initial period is in many cases impossible. Most commercial firms have limited call centers capacities, and can only reach a limited number of customers per day. Lastly, many spreading models assume that if a certain number of neighbors of a person adopt a product, the person will adopt it as well. While this might be true, in many cases one might be willing to adopt a product or service following good recommendations from friends, but he does not adopt it simply because he is too busy to actively reach the company and acquire the product or service.

Nevertheless, if reached by a sales person, he might be likely to adopt the product or service.

The Latent Viral Model provides a new framework, that overpass the obstacles mentioned above. It assumes from one hand that nodes accumulate social information, and that this accumulated information is a major factor in the adoption decision. However, in contrast to the previous Independent Cascade philosophy, it assumes that new nodes cannot become infected solely by a viral process. Instead, an external effort of a sales representative is required before a node actually becomes infected. Thus, the question of seeds allocation is relevant not only in the initial stage, but also along the entire spread process.

In comparison to the SOCIAL_CLUSTERING or SCHEDULED_SOCIAL methods described above, the LVM method better fits cases where the real values of customers likelihood to adopt and purchase a product following a recommendation is lower, and an additional effort from the sales personnel is generally required.

Correspondingly, the challenge is to decide on what node it is worthy to invest the seed and at what period. This decision is based on the feedbacks received from previous seed attempts along the current social network structure. Such feedbacks include the knowledge of customers that have already adopted the product, along those who have not. As shown in the result section, when using the LVM model, the success rates of the seeds trials grow if the Scheduling Seeding Heuristic (SSH) is used. A more formal description of the model followed by the heuristics used to select the seeds is presented in the next section.

The Proposed Model

Let us consider a company with good visibility on the social network of its clients. The company wants to offer its customers a new service or product (we use the term service or product interchangeably), and offers it through its sales representatives. The company seeks to achieve the highest possible number of customers that adopt the new service, and allocates a limited budget, denoted by B, to promote this goal.

If the company offers the service to a customer; let us say v, the customer might accept or reject the offer with a certain probability p. This probability is affected by the adoption rate of the service by the customer's social circle, as further explained below in eq. (1). In a case where the customer refuses the offer, subsequent offers in the near future will only annoy the customer, and therefore the product would not be offered again to the same customer. In such a case the customer's state is considered to be in a “Seeding Failed” state.

The social influence is such that if a customer accepts the offer, the customer is likely to influence his/her friends for the next t^{inf} periods. In this case, after t^{inf} periods have ended, he the customer changes from a state of being infected and infectious, to a state of being infected but not infectious. This state change reflects the retention loss, or the loss of interest in the message due to information overload (Weng, Flammini, Vespignani, & Menczer, 2012). The possible states of a customer are denote by Stᵥ and as defined below.

$${St}_{v} = \{ \begin{matrix}0 - Non \text{-} Infected \\ 1 - Infeted and Infectious \\ 2 - Infected , Non \text{-} Infectious \\ 3 - Seeding Failed\end{matrix} \qquad ( 1 )$$

The various states changes Stᵥ that customer v might follow, are presented in the states transition scheme 200 in FIG. 11. Non-infected state 0, infected and infectious state 202, infected and non-infectious state 203 and seeding failed state 204. The seeding failed state 204 may be followed by state 201 after a predefined “cooling” period (T_ct).

Defining the Probability of a Successful Seed Attempt

The probability that customer v accepts an offer is affected by the social pressure executed on the customer, as well as the attractiveness of the proposed product or service itself. We therefore define a maximal probability for an infection (adoption) by the proposed service or product, and denote it by p_{Max}_{ᵥ}. This parameter depends on the type of product or service, and can usually be estimated from past data. For example, the probability of accepting an offer for three months free cable TV service without any commitment might be rather high, while the probability of accepting an online purchase of a new luxury car is low. The probability of accepting the proposed offer follows eq. (1), where Nᵥ⁺ is the set of indexes of the infected (Stᵥ=1) neighbors of customer v, and θᵥ is the minimal number of infected neighbors at probability p_{Max}_{ᵥ}.

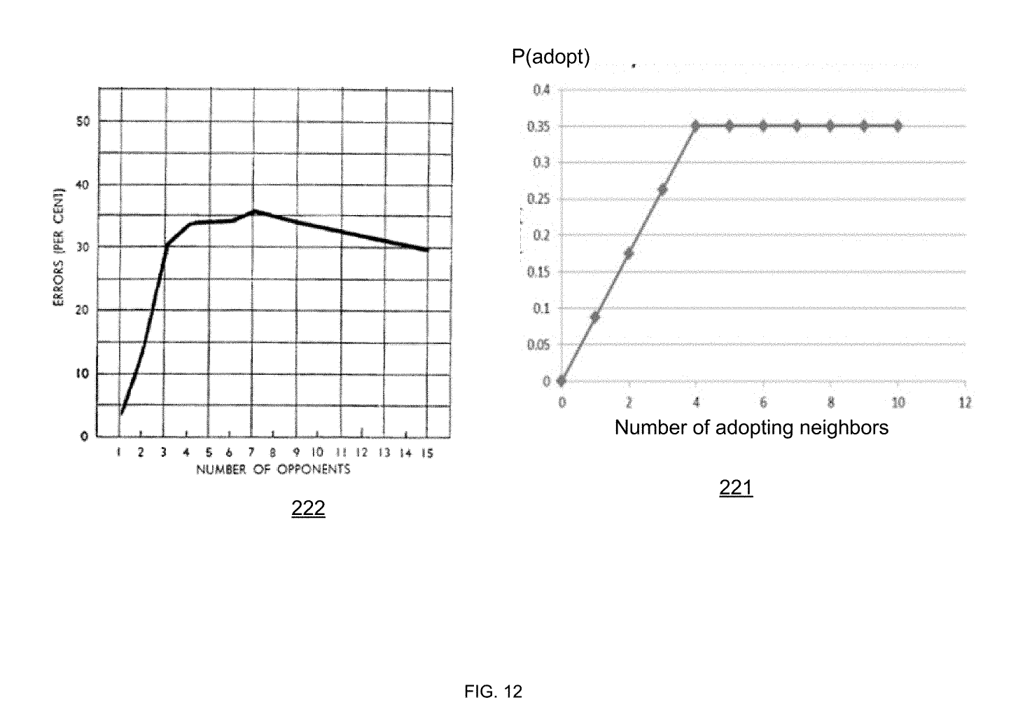

This formulation fits the results appearing in Asch's conformity experiments, which inspected the probability of conforming to norms as a factor of group size (see FIG. 12)

$${p}_{v} = {p}_{{Max}_{v}} \cdot ( \frac{min ( θ , \vert {N}_{v}^{+} \vert )}{θ} ) \qquad ( 1 )$$

In his works, Asch inspected how group size influences the probability of conforming to the opinion of the majority. As the coalition of this majority grows, the conforming probability grows almost linearly, until a certain coalition size (see graph 221), where we denote this value by θᵥ. Note that larger coalitions above θᵥ will not increase the likelihood of conforming any more. This influence function is plot in FIG. 12 (see graph 222) which presents the probability of conforming as it was copied from Ash's original article on social conformity. In comparison, the same right image of the figure presents the approximated function as defined in eq. (1). In both figures, the x-axis represents the number of people adopting the opinion, and the y-axis indicates the equivalent probability of acceptance, with the peak y-axis equal to p_{Max}_{ᵥ}.

FIG. 12 illustrates a social influence function based on Asch's conformity experiment. Graph 221 is directly copied from Asch's article, as compared to graph 222 which presents an approximation function as defined by eq. (1), with parameters pₘₐₓ_{ᵥ}=0.35 and θᵥ=4.

The Pre-Seeding and Seeding Processes

According to the definition of the acceptance probability as defined in eq. (1), if there is not even one infected node in the entire social network graph G=(V,E), the term |Nᵥ⁺|=0; ∀vε V. It follows that pᵥ=0; ∀vεV, and if course, in such a case, no seed trial would succeed. To prevent of being trapped in such a zero attractor, prior to the spread process, we define an initial set of infected nodes and set them to state Stᵥ=1; i.e. infected and infectious. These nodes are chosen randomly from V, and this pre-seeding infected set is defined by F^{init}. The relative size of |F^{init}| is usually small, and consists of less than 1% of the nodes. Furthermore, the infection times of the nodes in F^{init} are set such that each of these nodes has a different initial infection time, thus they do not change from Stᵥ=1→Stᵥ=2 at once but rather gradually.

Following the initial setting of F^{init}, the seeding process starts. The process includes B seeds attempts, which are performed on selected nodes. Assuming each seeding attempts costs exactly one unit of budget, and Mₛ nodes can only be seed at each period, these limitation fits real scenarios in which call centers can only make a limited number of phone calls per day due to their work hours constraints.

The Latent Viral Marketing model includes three steps. First, the algorithm chooses a set of nodes that are not yet infected, but have at least one infected neighbor. These are the potential candidates for the seeds. Second, it computes an “attractiveness” score for each of these candidates. Third, in each period, Mₛ nodes with the highest scores are seeded.

After the seeding is performed, the simulative stage “decides” if the seeds are accepted or rejected. The seeding trial succeeds or fails with a probability p, which as defined according to eq. (1). After the seeding of each period, relevant parameters and state changes are executed for the relevant nodes in the network. These include the calculation of Nᵥ⁺ for each node, as well as changes of states for odes that require such a change. This process ends when the entire budget is depleted, or when all the nodes in the network becomes infected. Once the process ends, the ratio of successful seeding is computed, simply as the number of seeding successes per seeding trials.

The Seeding Scheduling Heuristics (SSH) Score Computation.

The SSH recommended the seed trials by computing their score (Named LVM scores) at each step. The score is based on the expected value of the node being seeded, and reflects the probability of an occurrence of an event p(ψ), multiplied by the utility U(ψ) of the event. The event ψ, is defined as the success in a seed of node v.

The utility function gained from ψ is constructed from two separate parts. First, the success seeding of v has a utility of one additional infection node. Second, to this term, an additional term is added as the utility gained from the increased probabilities of future successful seeding of the uninfected neighbors of v. Since v is now infected, its neighbors are now easier to seed. The first term, the utility gained from the successful seeding of v simply equal to 1. The second term; the increased probabilities of uninfected neighbors of v is defined as the sum of changes over all nodes uεNᵥ⁻ where Nᵥ⁻ denote the non-infected neighbors of v. Assuming the event ψ occurs, this second term is the value of the nodes Nᵥ⁻:ψ minus their current value Nᵥ⁻:ψ̅. Thus, the utility from seeding trial to v is U(v)=Σ_{uεN}_{ᵥ}_{^{−}}·p(ψ)·U(ψ)−Σ_{uεN}_{ᵥ}_{^{−}}·p(ψ̅)·U(ψ̅), where ψ is the states of the neighboring nodes uεNᵥ⁻ after the seed of v succeeded, and ψ̅ is their states before the seed of v succeeded. This is a recursive formulation, since U(ψ̅) is actually unknown.

The computation method to calculate this score, is performed recursively, and is defined for a depth of 3 recursion levels in eq. (2). The recursive computation of the score, for a depth of k iterations, is presented in the following algorithm, and is later named as the seeding strategies “picky_social_<k>”; i.e. “picky_social_0”, “picky_social_1” and “picky_social_2”, where picky_social_0 computes the score simply as the term p(v), picky_social_1 as p(v)*{1+Σ_{uεN}_{^{−}}₍ᵥ₎p(u)*]} and picky_social_2 as the full in eq. (2).

Score(v)=p(v)*{1+Σ_{uεN}_{^{−}}₍ᵥ₎p(u)*(1+Σ_{wεN}_{^{−}}₍ᵤ₎p(w)*]} (2)

This attractiveness score is computed recursively as defined in the pseudo-code below in the SSH scoring algorithm.

The SSH Scoring Algorithm

Function Social Score(v, G, k):
# input: v - relevant node, G - Graph, k - Levels
(Social_0, Social_l, Social_2)
$Set p ( v ) = {p}_{{Max}_{v}} ( \frac{min ( {θ}_{v} , \vert {N}_{v}^{+} \vert )}{{θ}_{v}} )$
# Probability of infection of v in current time step
if Levels = 0:
return p(v) # Level 0 - Greedy score
else:
set Score = 1
for u in N⁻(v) go over all v's non-infected neighbors
score = score + Social(u, G, Levels - 1)
return p(v) * Score

To clarify the above recursive method, note that the expected value of v itself is p(v)*1, and the expected value of u (where v is the 1^{st} circle) which were not infected is p(v)*p(u|v)*1, meaning an occurrence of both events (successful infection of v and afterward successful infection of u which is based on a new probability calculation. Similarly, the expected value of w (where v is in the 2^{nd} circle, and u is in the 1^{st} circle, is: p(v)*p(u|v)*p(w|u,v)*1), which is the formulation defined in eq. (2).

While the above function computes the scores at any level of k, as further seen in the result section, there is a tradeoff between the effort to foresee and the time of computation. In most cases, it seems as the right balance is in one single level of depth, that is, in setting the parameter k=1. At this depth of recursive, the results are rather good, but the additional computation complexity dramatically increases. In the next section, we present the methods used to evaluate the efficiency of the above SSH scorings under the LVM modeling, followed by the results from these sets of experiments.

Experimental Setup Used to Validate the Method's Efficiency

We set an empirical experiment in order to compare the performance of suggested and existing benchmark seeding heuristic. Each simulation instance started with a setup of the initial condition, which included a selection of a pre-simulation infected set F^{init} as defined above. The infected time of this set were generated from a uniform distribution, such that there would not be a sharp decline in the infectious nodes at period t=t^{inf}+1.

As the simulation started, in each period, a seed was offered to a single node, whereas the selection of the seeded node was based on different heuristic rules. Each seeded node could accept or reject the seed with a probability based on its surrounding nodes according to eq. (1), and the node's state function changes were calculate at each discreet period. The simulation instance ended when the entire budget was used, then, the final seed success to failure rate was calculated.

The results can be used to examine the different seeding strategies and compare them across changing dimensions of initial parameters, such that at each set of simulations, a single dimension was examined across a wide range of values. The other parameters were set to their default values, which were in most cases the median of the range.

During each simulation run, the SSH seeding recommendations under the LVM simulations was compared to the benchmark seeding methods, throughout the entire parameter space, while running each parameter combination for at least 400 replications. The entire parameter space as used in the simulation experiment is presented in Table 1 below.

TABLE 1
Simulation Parameter Space

| Parameter | Values |
|---|---|
| Network (see Table for further | Sampled Citation network, Slashdot |
| details). | Network, Sampled EuEmail network, |
| | WikiVote Network, Epinions Network, |
| | Enron Network |
| Network size (sample # nodes) | 5000, 10000, 50000, 100000, 500000, |
| | 1000000 |
| Initially infected population size | 50, 100, 200, 500, 1000 |
| Max Budget | 50, 100, 200, 500, 1000 |
| Threshold | 3, 4, 5, 6, 7 |
| Maximal Probability | 0.1, 0.3, 0.5, 0.7, 0.9 |
| Infection Time (Time of | 10, 20, 50, 100, 200 |
| Oblivion) | |
| Seeding method (our method | Random, GEC, Picky Random, |
| and the benchmark methods) | Picky_GEC, LVM (Picky_Social_0, |
| | Picky_0ocial_1, Picky_0ocial_2) |

Three different SSH seeding recommendations under the LVM simulations scheme i.e. Picky_Social_0, Picky_social_1, Picky_social_2 were compared to four benchmark methods which included (1) Random, (2) GEC, (3) Picky Random, (4) Picky GEC as further defined in the next section.

These simulations were executed on different networks as defined in Table 2 below.

TABLE 2
Networks¹ Used in Simulation

| | Number of | Avg | Avg | Network |
|---|---|---|---|---|
| Network | Nodes | Degree | Clustering | Type |
| Citations | 1000000 | 2.83481 | 0.039113922 | Sampled & |
| | | | | Undirected |
| Citations | 500000 | 4.057372 | 0.060063242 | Sampled & |
| | | | | Undirected |
| Citations | 100000 | 7.60482 | 0.136068811 | Sampled & |
| | | | | Undirected |
| Citations | 50000 | 8.19712 | 0.160465584 | Sampled & |
| | | | | Undirected |
| Citations | 10000 | 6.809 | 0.200986075 | Sampled & |
| | | | | Undirected |
| Enron | 36692 | 10.020222 | 0.49698256 | Full & |
| | | | | Undirected |
| Wiki_vote | 7115 | 28.323823 | 0.140897846 | Full & |
| | | | | Undirected |
| Slashdot | 82168 | 14.179072 | 0.06034486 | Full & |
| | | | | Undirected |
| Euemail | 100000 | 1.56686 | 0.034104364 | Sampled & |
| | | | | Undirected |
| Epinions | 75879 | 10.694395 | 0.137756373 | Full & |
| | | | | Undirected |

The Benchmark Methods

The evaluation of the SSH seed recommendations method for the LVM scheme, was compared to the four benchmark methods below.

a. Random—Randomly choosing one uninfected node to seed at each time step
b. GEC—Choosing the one uninfected node with the highest Eigenvalue Centrality measure at each time step.
c. Picky Random—Choosing a random uninfected node from the nodes which have at least one infected and infectious neighbor.
d. Picky GEC—Choosing an uninfected node with the highest Eigenvector centrality from the nodes that have at least one infected and infectious neighbor.

These benchmark methods were compared to these three SSH social heuristics.

e. Picky_Social_0—Choosing a non-infected node with the highest value of p(v) at each time step, see SSH Scoring Algorithm with k=0.
f. Picky_Social_1—Choosing the non-infected node having the highest value of Score(v) as defined in the first part of eq. (2), and the SSH Scoring Algorithm with k=1.
g. Picky_Social_2—Choosing the node having the highest value of Score(v) as defined in eq. (2) and the SSH Scoring Algorithm with k=2.

In the simulations, we first assume that the values of the parameters θᵥ and p_{Max}_{ᵥ} are known. In the second set of experiments, we assumes that we only know the mean and variance of these parameters, along their distribution. The means are denoted by μ_{θ} and

$${μ}_{{p}_{{Max}_{v}}} ,$$

and the variance are denoted by σ_{θ} and

$${σ}_{{p}_{{Max}_{v}}}$$

accordingly. The real value of these parameters for each node were generated prior to each simulation run, and were not preliminarily known to the SSH recommendation algorithm.

Centrality of the Nodes Chosen to be Seeded

The Eigenvector Centrality measure of a node (as well as its PageRank score) are considered as a good proxy for a node's ability to spread information. The main concept behind the LVM Scheduling scheme is that it is not only the centrality of the node that defines its importance, but rather its tendency to accept the information at any precise period of time.

Before presenting the entire sets of results, we thus first examine the nodes chosen for the seeding at each period in regards of their Eigenvector centrality. This inspection allows us to validate that the success of the SSH method is not simply because it prefers seeding central nodes.

We compare the Eigenvector Centrality of each seeded node along time, when using the GEC method, a method that allocates the seed to the relevant non-infected nodes by their Eigenvector Centrality scores, to the scheduling methods by the LVM method (i.e. named Social).

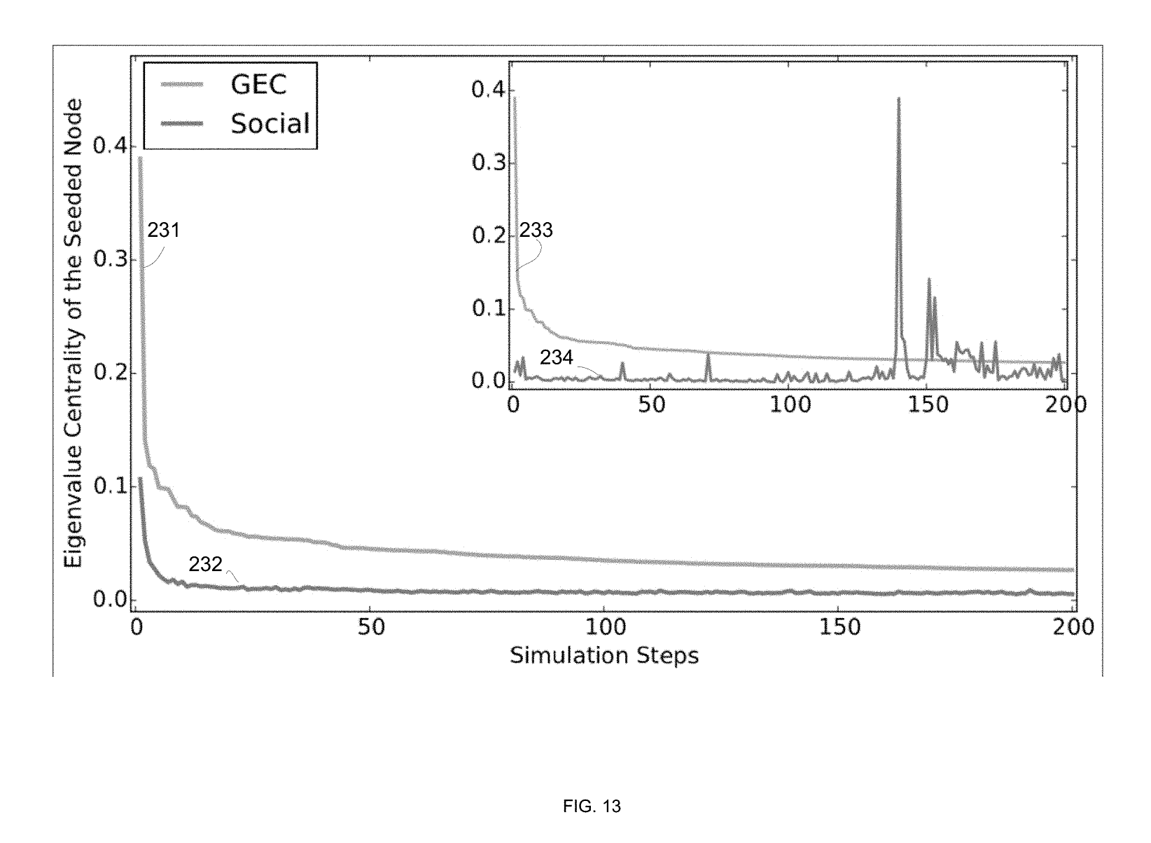

A comparison presenting the centrality of the selected nodes in the LVM method is presented in FIG. 13 below.

The SSH Social method (curves 232 and 234 “Social”), allocates seeds to nodes with relatively lower average Eigenvalue Centrality, as compared to the GEC method (curves 231 and 233 “GEC”). While in a single run (presented in the interior plot of the figure—curves 233 and 234), we can see that nodes with high Eigenvalue Centrality can be seeded in a rather later stages, the average Eigenvalue Centrality (presented in the exterior plot—curves 231 and 232) of the nodes along time is substantially lower for the SSH.

It can be concluded from those first results that the LVM method does not allocate the seeds to central nodes, but rather that it allocates them to nodes that are of high importance at any current point in time. As is further seen, the SSH selection of nodes does not only allocate seeds to less central nodes (which in reality might be easier to reach), but rather results in final success rate that is substantially higher that of the benchmark methods for any given budget.

In FIG. 13 the x-axis is the time of seed attempts and the y-axis is the Eigenvector Centrality of the node on which the seeding attempt is performed.

Comparing the LVM with the Benchmark Methods

We start by comparing the SSH method to the benchmark methods, for different network sizes.

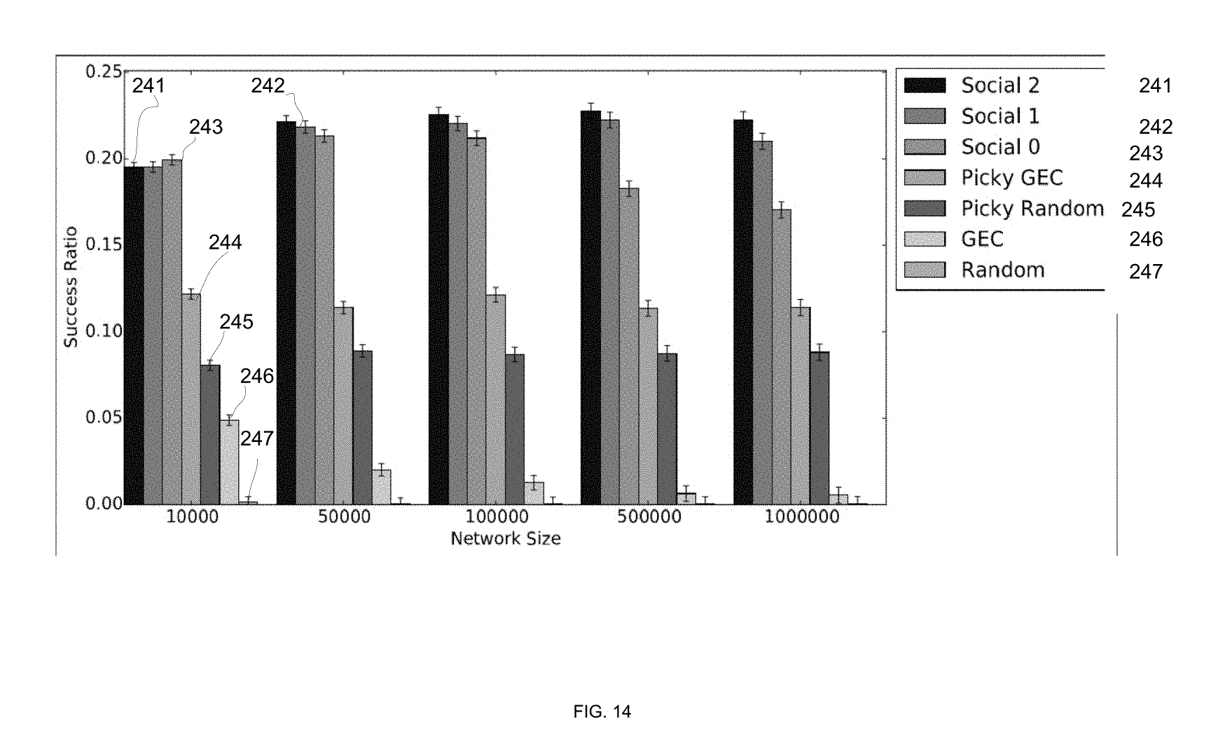

FIG. 14 illustrates comparisons between methods that were applied on networks of sizes of 10,000 (leftmost set of bars), 50,000, 100,000, 500,000 and 1,000,000 (rightmost set of bars).

Each set of bars includes seven bars that represent (from left to right) Social 1 241, Social 1 242, Social 0 243, Picky GEC 244, Picky Random 245, GEC 246 and Random 247.

As can be seen in FIG. 14, the social methods outperform the benchmarks methods by almost twice. For all the different seeding methods, the Social 2 method seem to reach the best results, followed by the social 1 and the Social 0 methods. In comparison, the benchmark method of Picky GEC, a method that allocates seeds to nodes with the highest Eigenvector Centrality in condition that these nodes already have at least one infected neighbor, only succeeds at about ˜13% as compared to ˜20% success rates for the Social method. Note that the GEC and the Random methods practically used by many commercial firms that do not include the network structure of their clients in their marketing efforts. The success rates in these methods are far lower.

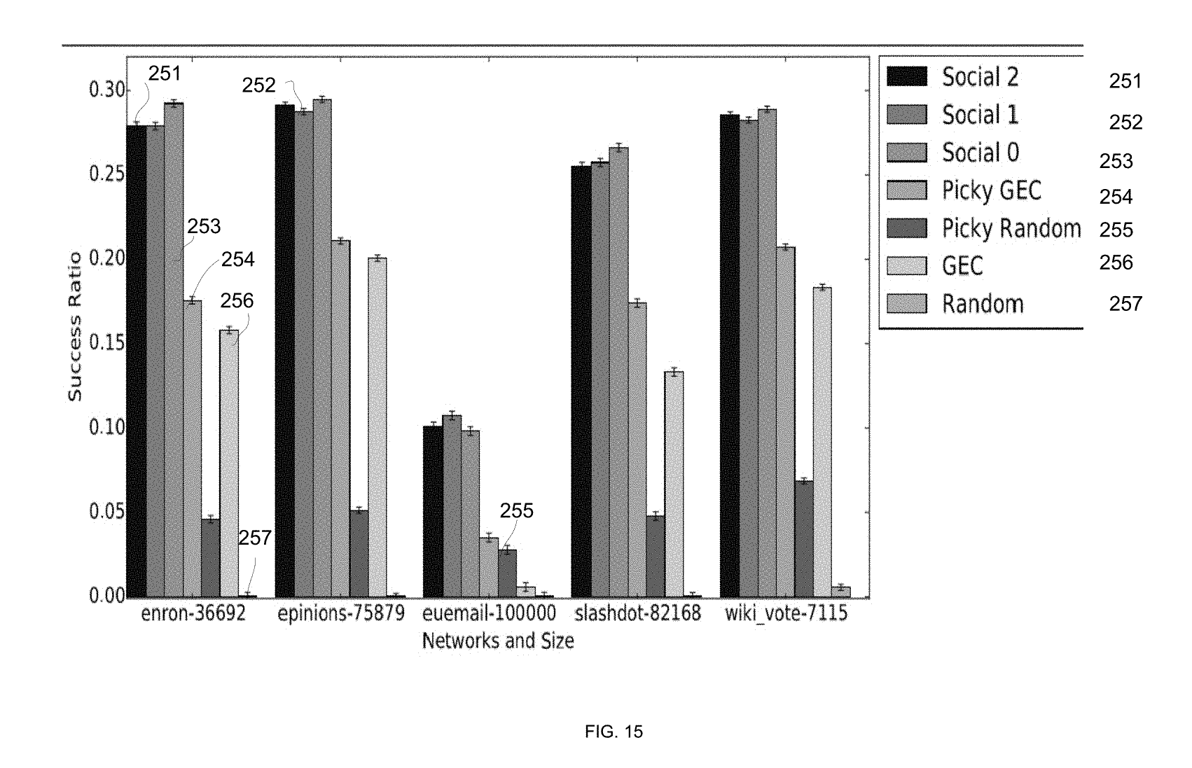

The results in FIG. 14 are on sampled citation networks of different sizes. We follow these results and validate them for different networks, on diverse average degrees and Clustering Coefficients of FIG. 15. Comparison of SSH Scheduling method to the benchmark methods for different networks topologies.

FIG. 15 illustrates comparisons between methods that were applied on networks enron-36692 (leftmost set of bars), epinions-75879, euemail-100000, Slashdot-82168 and wiki-votw-7115 (rightmost set of bars).

Each set of bars includes seven bars that represent (from left to right) Social 1 251, Social 1 252, Social 0 253, Picky GEC 254, Picky Random 255, GEC 256 and Random 257.

As seen in FIG. 15, the results are mainly similar. Note that the euemail-100000 network has substantially lower success rates as compared to the other networks. To understand these results, we need to look at the average degree of this network and compare it to the average degree of the other networks (see table 2). While euemail-100000 network has an average degree of 1.56, the other networks have an average degree of 10.7 or higher. The low degree in the euemail-100000 network reduces the probability of any seed success, since in the LVM model, the number of infected neighbors is a major factor influencing the probability of a successful seed, when the network is sparse, and this probability is accordingly low.

Note also that in these results, unlike the case of the generated network, the Social 2 is not always the best method. Similarly, Social 1 is not always better than Social 0. It seems as in reality, when the network topologies differ, in many cases it is better to use the simple Social 0 and Social 1 heuristics over the more complex Social 2 heuristics which tries to plan forward for two steps in advance.

The GEC methods seed nodes with high Eigenvector Centrality in earlier stages. This might create a larger influence at early stages and improve the acceptance rates later on. In order to inspect the temporal aspect of the spread, we measured the success rates of the different seeding methods along the time axis. These results, as presented in FIG. 6, indicate a growth in the success rate along the time axis.

The growth is larger in the Social seeding methods, as compared to the non-social methods (yellow or green). The growth in the success ratio seems to follow a log like function, since the y-axis is the ratio and not the absolute number. These results imply that for growing budgets (growth in time) we expect a constant benefit from using the social methods as compared to the benchmark methods.

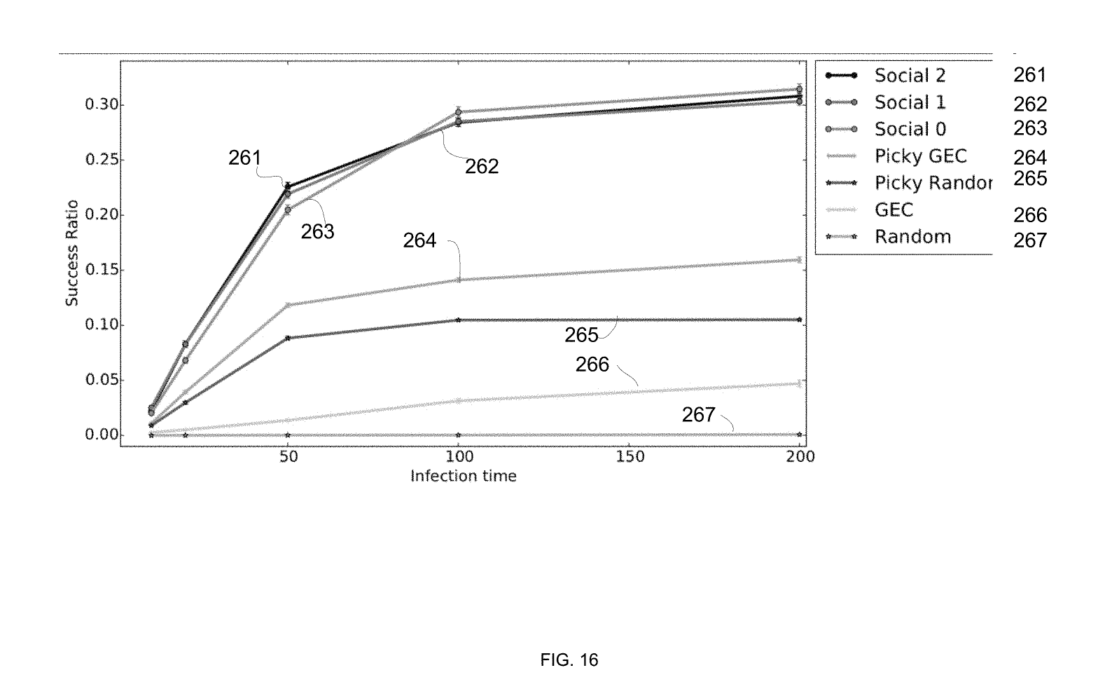

FIG. 16 illustrates temporal comparison of the aspect of the SSH Scheduling method to the benchmark methods.

The y-axis is the success ratio and the x-axis is infection tome.

Curves 261-267 represent Social 1 261, Social 1 262, Social 0 263, Picky GEC 264, Picky Random 265, GEC 266 and Random 267.

As described in the proposed model section, prior to the seeding attempts, the states of nodes in F^{init} were set to Stᵥ=1. We inspect the influence of the size of F^{init} on the different seeding methods.

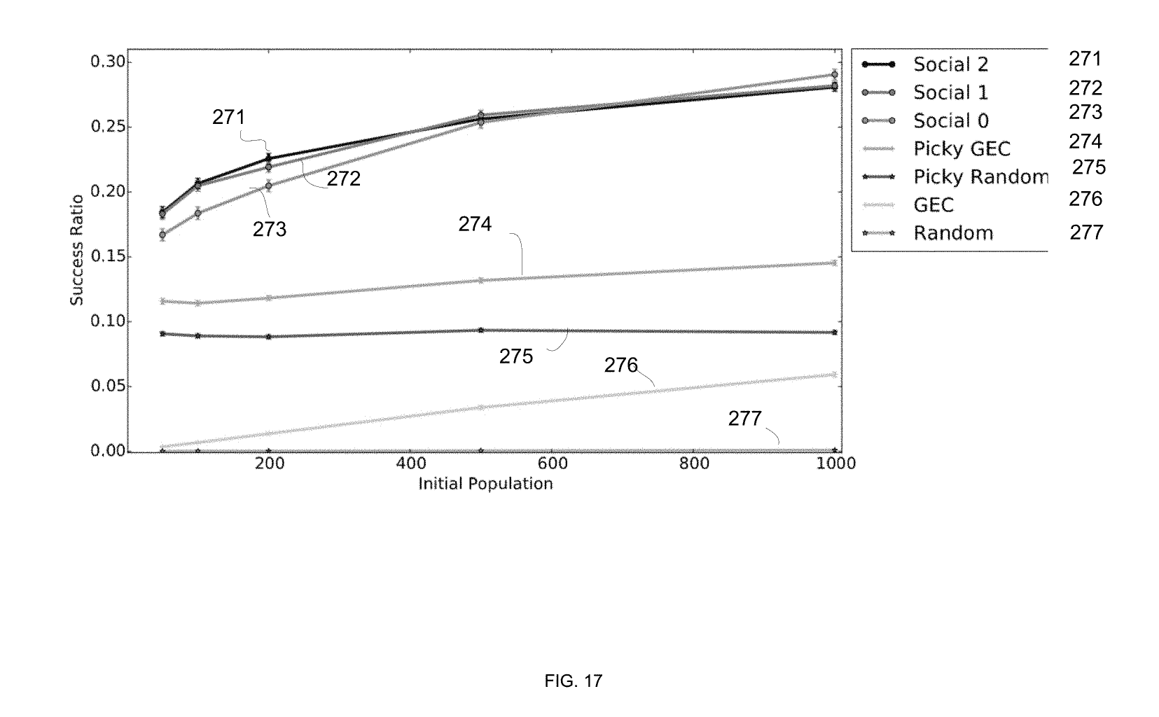

As demonstrated in FIG. 17, a larger initial population in F^{init} (x-axis) improves the relative utility of the Social methods. The y-axis is the success ratio and the x-axis is infection tome.

Curves 271-277 represent Social 1 271, Social 1 272, Social 0 273, Picky GEC 274, Picky Random 275, GEC 276 and Random 277.

When the initial set F^{init} consists of only 50 infected nodes, the Social methods succeeds in the seeding 16.6%-18.4% of the seeding attempts. In comparison, the Picky GEC methods succeeded in the seeding of 11.5% and the Picky Random only succeeds in 9% of the cases. This is an improvement of 44% for the Social methods. As opposed to this initial setting of F^{init}, if F^{init}=1000, the social methods succeeds in seeding 29%-28.1% of the seeding attempts, while the Picky GEC and Picky Random only succeeded in 14.5% and 9.1% which is an improvement of 94%. Thus, the improvement of the Social methods over the next best methods grow from 44% to 94% as F^{init} grows.

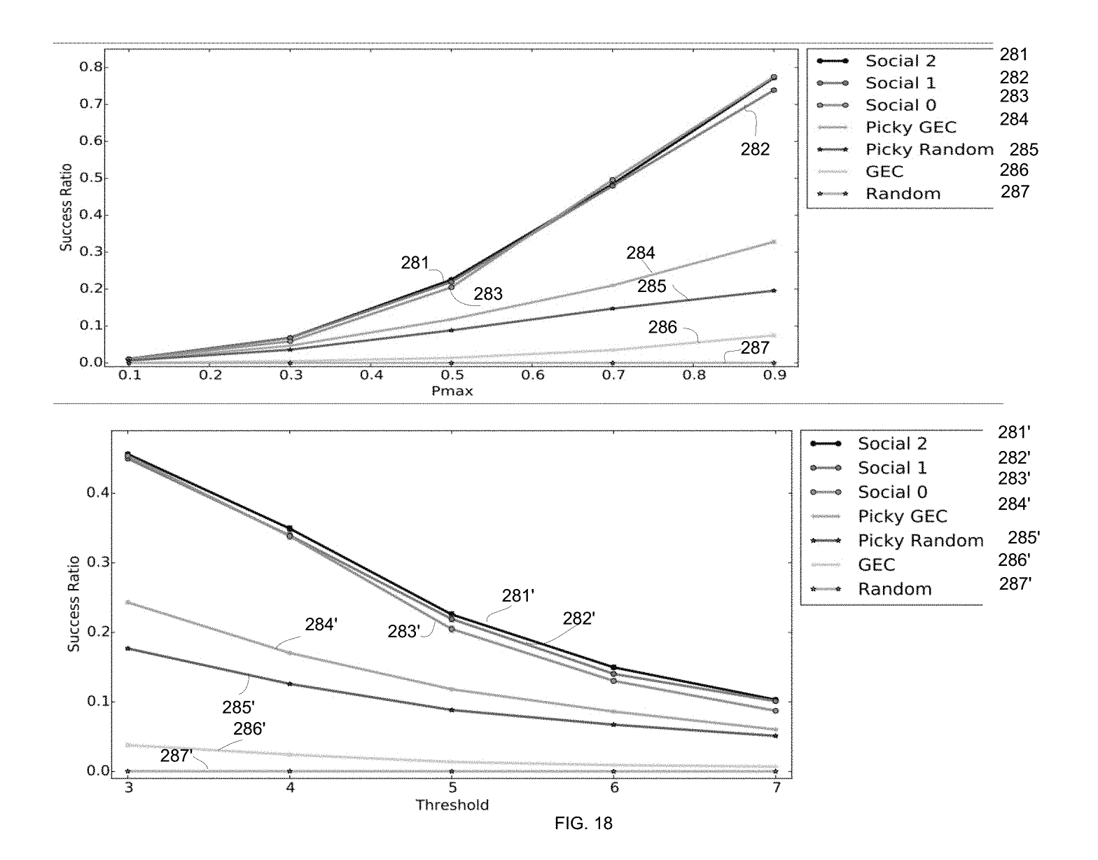

FIG. 18 illustrates an influence of pₘₐₓ (upper part) and θᵥ—the threshold (lower part) on the success rates of the Social methods compared to the benchmark methods.

Regarding the upper part of FIG. 18—the x-axis is Pmax and the Y-axis is the success ratio. Curves 281-287 represent Social 1 281, Social 1 282, Social 0 283, Picky GEC 284, Picky Random 285, GEC 286 and Random 287.

Regarding the lower part of FIG. 18—the x-axis is Threshold and the Y-axis is the success ratio. Curves 281′-287′ represent Social 1 281′, Social 1 282′, Social 0 283′, Picky GEC 284′, Picky Random 285′, GEC 286′ and Random 287′.

The influence of pₘₐₓ and θᵥ on the results can be observed in FIG. 18. It is clear that higher values of pₘₐₓ (left image), only improves the efficiency of the Social methods as compared to the other benchmark methods. This result make sense. A product or service that have a large value of pₘₐₓ are those that have a larger probability of purchase if one's friends have purchased. For example, such products can be trendy products for teenagers or kids, where the social influence plays a large role in the desirability of the product. For these products, it would be reasonable to assume that the LVM method, a strategy that better incorporates the social aspect of the purchasing decision would be beneficial over more static approaches, which only include the network topology.

Regarding the threshold value θᵥ as presented in the right figure, higher values of θᵥ represent products where one need to accumulate more adopting neighbors before one reaches a purchasing maturity. Products or services that fit the category and are expected to have high values of θᵥ, are products or services where one tends to accumulate much information prior the purchasing maturity. These can be important (and costly) decisions such as buying a new car or new home. In these important decisions, where one tends to invest one's time and effort in profound inquiries prior the purchasing decision, the social aspect is less dominant. While the trend seems to continue such that the social LVM methods are always preferred, these are decisions where the success ratio is also small. Note that such cases as expensive decisions, the social methods (when one consults as many as 7 friends) is 8%-10% for the Social methods, as compared to 6% for the picky GEC method. This represent an improvement of at least 33% for the Social methods over the best of the other methods, which in a case of an expensive product or service is a very good result.

Inspecting the Simulations Space with Unknown Parameters

The results described in the section above assumed that the values of pₘₐₓ and θᵥ are known. Of course, this is not true. At the best, the distribution of these parameters can be estimated, but the individual parameter for each node is never known. For this reason, we conducted another set of experiments and inspected the performance of our scheduling method under the LVM for unknown values of p_{Max}_{ᵥ} and θᵥ. In these experiments, the means and standard deviations of p_{Max}_{ᵥ} and θᵥ were known, but the true value of these parameters for each node was not revealed to the Scheduling algorithm.

We thus first generated value for p_{Max}_{ᵥ} and for θᵥ prior the run, then run the different seeding methods while not letting the algorithm know the values of the parameters for each node. In each run, the Scheduling algorithm simply generate a possible value for p_{Max}_{ᵥ} and θᵥ from their means, standard deviations and distributions and continued to search for the best node as if their values were known. We assumed the parameters distribution is a Normal distribution, and inspected the influence of growing rates of errors rates with growing standard deviations of these parameters.

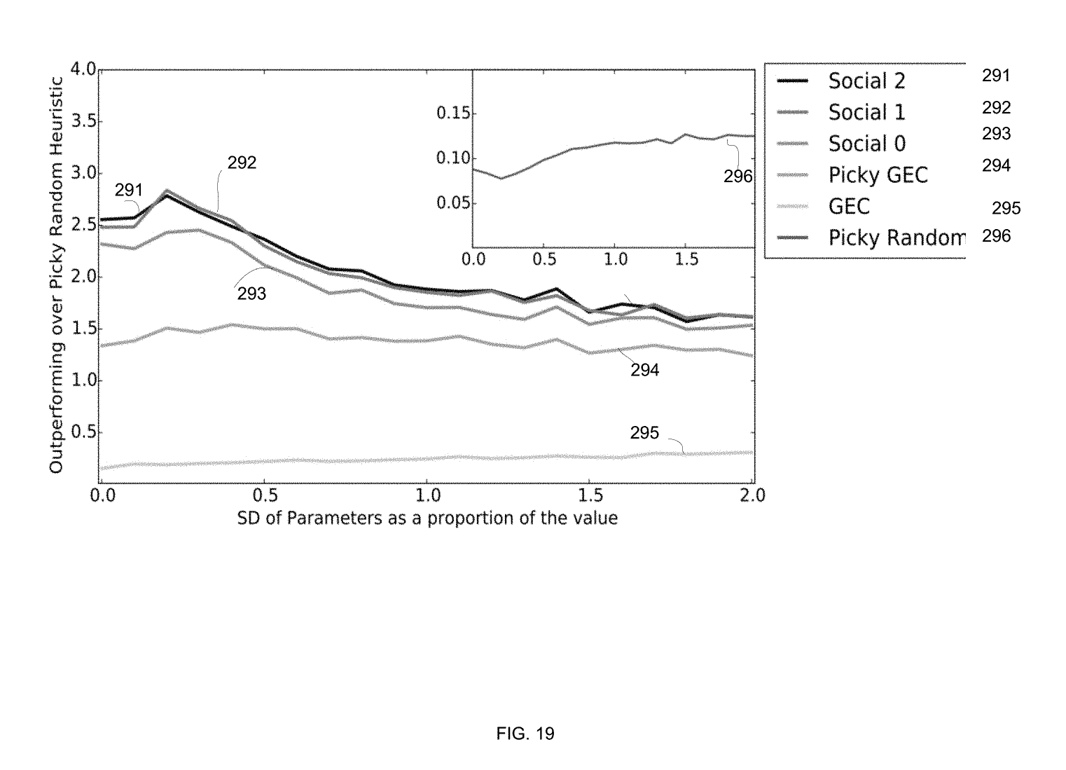

As seen in FIG. 19, the growing degree of uncertainty (x-axis) of the real values of p_{Max}_{ᵥ} and θᵥ, results in a decreasing performance of the social LVM methods, as compared to the random method.

Regarding FIG. 19—the x-axis is the standard deviation (SD) of parameters as a proportion of the value and the Y-axis is a measure or the outperforming over Picky Random Heuristics. Curves 291-296 represent Social 1 291, Social 1 292, Social 0 293, Picky GEC 294, GEC 295 and Random 296.

We set the Picky Random method (which randomly selects nodes that have at least one infected neighbor) as a comparison line, and only inspect the degree in which each distinct method performs better than the random method. Note that for the random heuristics (inner plot); an addition of noise actually improves the performance of the method. If the values of p_{Max}_{ᵥ} and θᵥ have larger variance, it implies that in some cases p_{Max}_{ᵥ} and θᵥ would be low. In these cases, if the nodes selection is random, the probability of a seed success is high.

Since we compare the performance of each heuristics to this random heuristics, which grows with the addition of more noise, we expect that more “noise” to result in a less accurate plan of the Social method as compared to the random method. It can be seen, that even for the high levels of a standard deviation of as much as 2 standard deviations, the worst Social method (i.e. Social 0) still performs better than the random by 153%, and the best benchmark method (i.e. Picky GEC) only performs better than the random by 124%.

This represents an improvement of at least 23% for the Social method over the best other benchmark method. Furthermore, for smaller levels of standard deviations, (cases where we can better estimate the parameter values) the improvement of the Social methods as compared the other methods is substantially higher.

Additional Unknown Parameters of Minimal Probability of Adoption

The previous section inspected the behavior of the model when the parameters p_{Max}_{ᵥ} and θᵥ were unknown. These parameters represent the uncertainty related to the highest possible probability of seed success, in a case where there are many infected neighbors. There is nevertheless, another source of uncertainty, which was not addressed in the LVM model. This is the case of a product adoption when none of one's friend have never adopted it. It is clear that while social influence is an important aspect in the purchasing decision, there are cases where one purchase a product or service that none of one's friend have purchased.

As seen in eq. (1), when none of one's friends have adopted the product or service, the value of |Nᵥ⁺|=0, and the probability of adoption is accordingly 0. This difficulty in the model, of course needs a correction. In order to correct it, we redefined eq. (2), as below, by adding a minimal value p_{Min}_{ᵥ} to the term.

$${p}_{v} = {p}_{{Min}_{v}} + ( 1 - {p}_{{Min}_{v}} ) \cdot {p}_{{Max}_{v}} \cdot ( \frac{min ( {θ}_{v} , \vert {N}_{v}^{+} \vert )}{{θ}_{v}} ) * ]$$

The term p_{Min}_{ᵥ} thus represent the a priori probability of a node accepting a seed, when none of its neighboring nodes have accepted it.

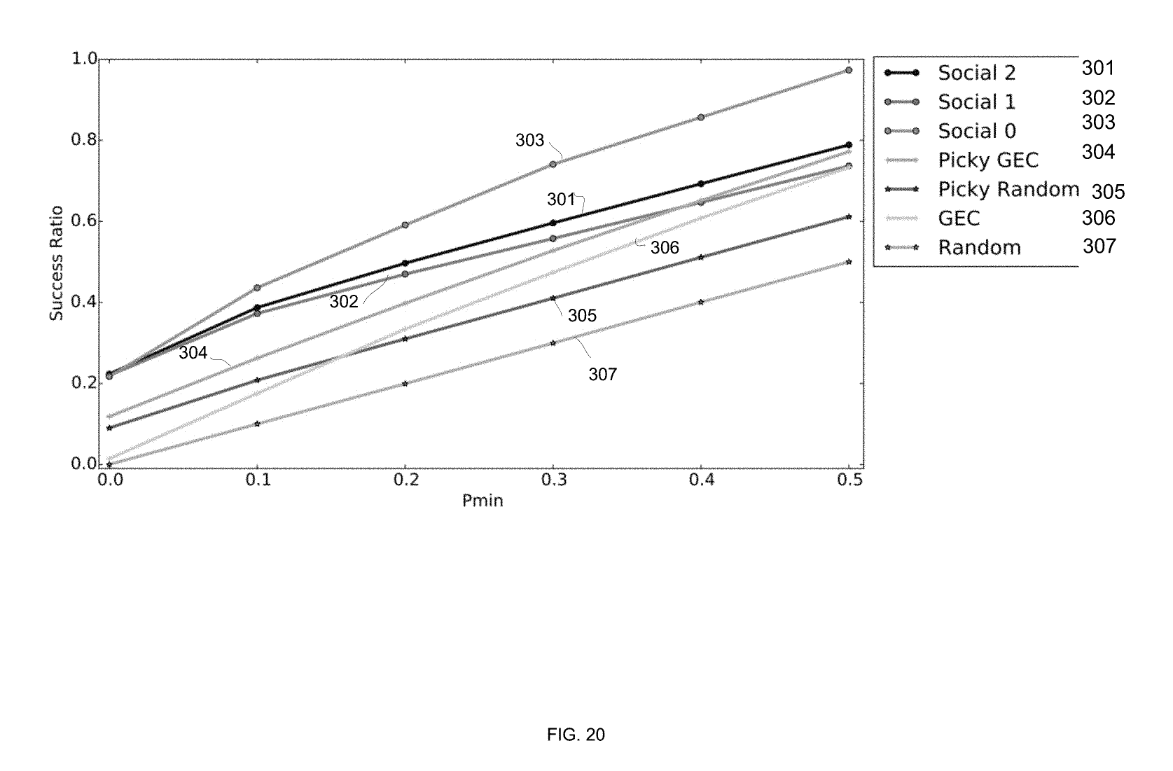

FIG. 20 illustrates the influence of p_{Min}_{ᵥ} on the success rates of the Social methods as compared to the benchmark methods.

Regarding FIG. 20—the x-axis is Pmin and the Y-axis is the success ratio. Curves 301-307 represent Social 1 301, Social 1 302, Social 0 303, Picky GEC 304, Picky Random 305, GEC 306 and Random 307.

The additional term p_{Min}_{ᵥ} to the LVM model, reveals two interesting properties of the LVM model and the Social heuristics. First, note that when p_{Min}_{ᵥ} is added to the LVM model, the Social 0 method outperform the other Social methods. This trend can be explained by the low ability of the more complex Social Algorithm to correctly predict the seeds success when noise is added. Furthermore, note that when the value of p_{Min}_{ᵥ} is p_{Min}_{ᵥ}≦0.4 the Social methods are still better than the other methods. In contrast, when the value of p_{Min}_{ᵥ} is p_{Min}_{ᵥ}>0.4 the Picky GEC methods gains better results over the Social methods.

These results define the region where the Social methods is expected to gain better results, and enable a better decision when to use the Social methods and when to use the GEC methods. With this in mind, it is important to note that the Picky GEC method does not simply allocate seeds to nodes according to their Eigenvalue Centrality, but rather restricts the nodes allocations to nodes that have at least one infected neighbor. It this includes some type of feedback on what node adopted the offer. If this feedback is ignored, then the correct comparison needs to be the GEC regime and not in the Picky GEC regime. In this method, seeds are allocated to nodes according to their Eigenvector Centrality without concerning their neighbors' state at all. In this case, only when 50% of the purchasing decision is personal (p_{Min}>0.5) it is better to use the GEC methods over the Social methods.

Run Time of the Social Methods

The different Social methods represent a growing degrees of future planning effort. While the Social 0 method is fully greedy, the Social 1 tries to plan one step ahead, and the Social 2 plans two steps ahead. Although the SSH scoring algorithm, as previously presented can be used with growing degrees of future planning, we did not find sufficient improvement in more than 2 steps plan ahead. This is important if considering the fact that when the networks size grow, the computational cost of the plan ahead grows accordingly. Furthermore, in many cases, a trial to plan for the far future might result in trial to seed nodes that are influential in the long term, but have lower probability of accepting the seed in the short term. Such a strategy can result in lower final success rates since these influential nodes seeding simply fails.

Note that the computation cost of computing the Eigenvector Centrality measure for very large networks is also rather expensive in computational time.

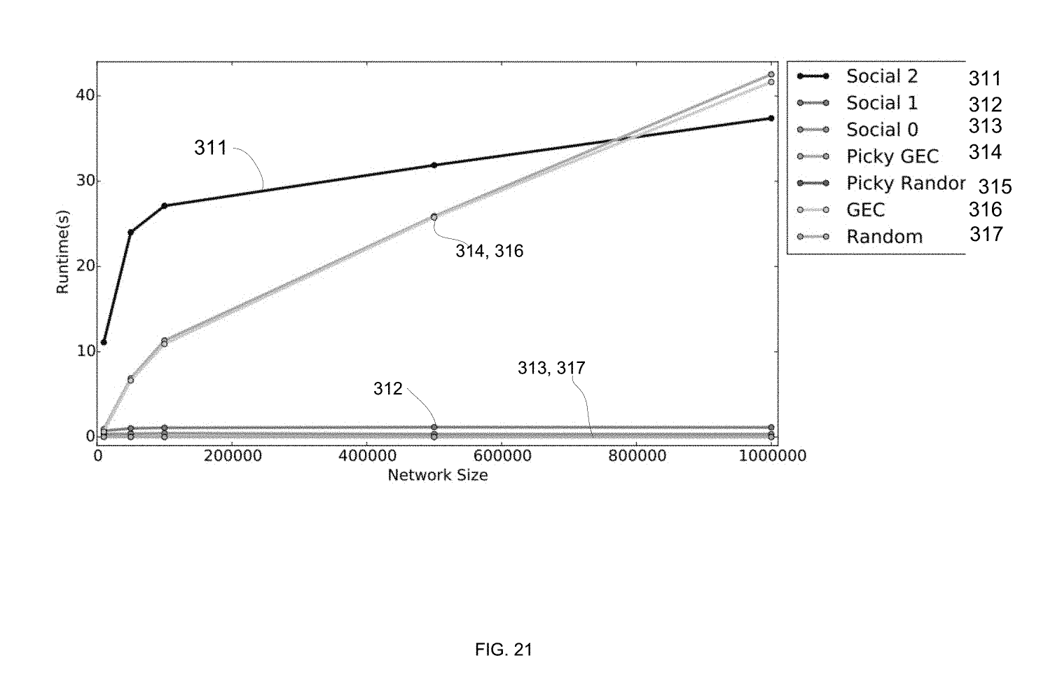

Referring to FIG. 21—the x-axis is the network size and the Y-axis is the runtime. Curves 311-317 represent Social 1 311, Social 1 312, Social 0 313, Picky GEC 314, Picky Random 315, GEC 316 and Random 317.

As seen in FIG. 21, when the network size grow near 800,000 nodes, the computational cost of the most expensive Social method, i.e. Social 2 is already better than that of computing one single time the Eigenvector Centrality measure. As contrast, in networks of sizes of |n|>800,000 nodes, the computational cost of the Social 1 and the Social 0 is still negligible. As much as a network of size |n|>1,000,000 nodes is still a very small network, the runtime is still less than 1 minute, thus it does not seem as the runtime in the Social methods is a real problem.

Many works that study information cascades in social networks, consider these cascades as a phenomenon by which information virally spreads by its own force through the links of the network. Unlike the spread of biological viruses that can be carried passively by agents and infect a significant portion of the network, information cascades are usually much shorter and long cascades are rather rare. These results do not necessarily imply that social forces lost their importance but rather that people information spread is more selective, and does not necessarily fit the use of an SIR model of virus spread.

There is provided a new information spread model, in which agents, e.g., sales representative of a company, communicate with network members, e.g., potential clients, and offer them a new product or service. The probability that a client accepts such an offer is based on the acceptance levels of its neighbors.

Since contacting a client includes some financial cost (limiting the number of clients that can be approached at once), the company has to select which members to approach and at what time, in order to increase the total adoption rate in the network.

The proposed Latent Viral Marketing Model and its recommendation method for customer selection, sees influential nodes, as nodes that are most likely to accept an offer at each period and thus influence others.

In a large series of simulated experiments, we show that the proposed method increases the adoption rate in 23%-153% (depending on the initial conditions), over the best-known method, which seeds the nodes by their Eigenvector Centrality measure.

The method may be applicable to products that have a viral characteristic. These are products or services where a substantial part of the purchasing decision is based on social influence. In products or services where social forces are not important, it might still be better to use the old method of selecting nodes that have high Eigenvalue Centrality measures.

The work contribution can be summarized along three different axes. First, the LVM spread model better fits real-world scenarios of products adoption, where products spread relies on an effort of a sales department, and seldom spread with no external force added. In these cases, this work directs the sales personals, where and when to contact each possible customer. Second, the proposed model demonstrates the importance and the high potential of a Scheduled Seeding approach, while restricting the scenarios to the cases where this method is expected to be useful, as well as those where it is not. Third, there is provided a simple, yet a powerful method (by the SSH algorithm), that can be easily applied in disserve situations of marketing of trendy product, where social forces are of high importance.

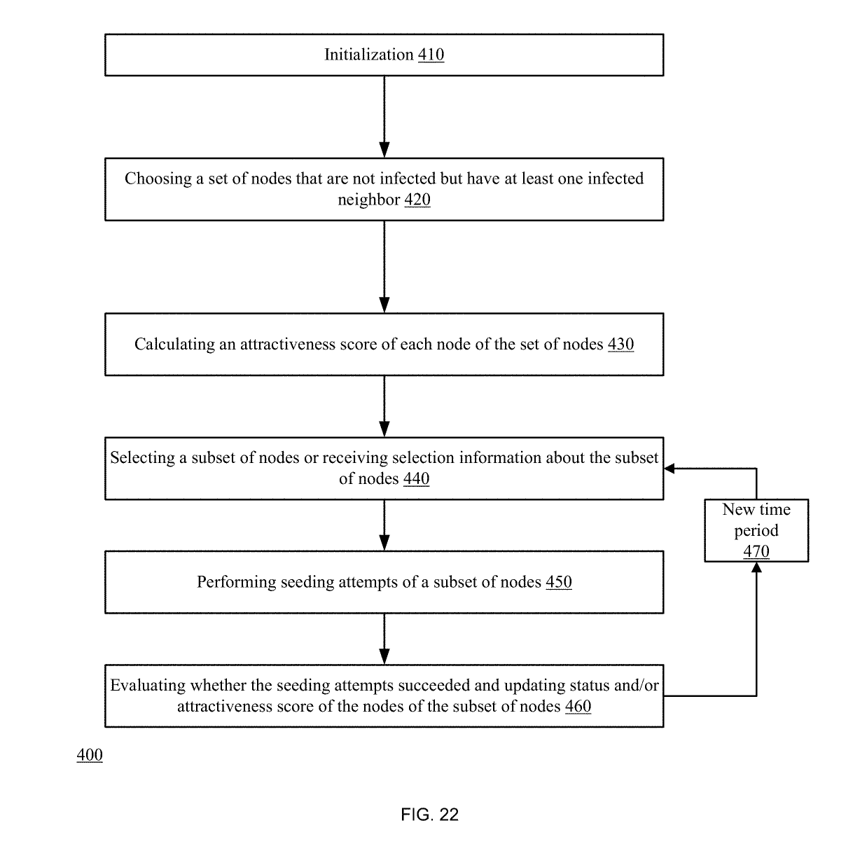

FIG. 22 illustrates method 400 according to an embodiment of the invention.

Method 400 may start by initialization step 410. The initialization may include receiving or determining an initial status of one or more social networks. The initial status may assume that some nodes are infected.

The initialization may include receiving feedback from previous iterations of method 400, receiving cost constraints and the like.

Step 410 may be followed by step 420 of choosing a set of nodes that are not infected but have at least one infected neighbor. Step 420 may be executed in a random or non-random manner.

Step 420 may be followed by step 430 of calculating an attractiveness score of each node of the set of nodes.

Step 430 may be executed one or multiple times and may be responsive to information about the user.

Step 430 may be followed by multiple repetitions of steps 440, 450 and 460—each repetition may “cover” a predefined time period (see step 470).

Step 440 may include selecting a subset of nodes or receiving selection information about the subset of nodes. The subset of node may include a predefined number of nodes, a varying number of nodes, and the like. The selection may be based on the attractiveness score—for example selecting the Nv most attractive nodes—for example—the nodes that have the highest attractiveness score.

Step 440 may be followed by step 450 of performing seeding attempts of the subset of nodes. The seeding attempts may be executed by a computer with or without human intervention.

Step 450 may be followed by step 460 of evaluating whether the seeding attempts succeeded and updating status and/or attractiveness score of the nodes of the subset of node.

Step 460 may be followed by step 470 (selecting a new time period) and then jumping to step 440.

Method 400 may also include receiving actual feedback about the success of the seeding attempts—and updating the status and/or attractiveness score of the nodes of the subset of node.

Step 460 may be based on a probability P of a success in a seeding attempt.

The probability that a customer v accepts an offer (seed attempt succeeds) may be affected by the social pressure executed on the customer, as well as the attractiveness of the proposed product or service itself.

Step 460 may include defining (or receiving) a maximal probability for an infection (adoption) by the proposed service or product, and denote it by p_{Max}_{ᵥ}. This parameter depends on the type of product or service, and is estimated from past data. For example, the probability of accepting an offer for three months free cable TV service without any commitment might be rather high, while the probability of accepting an online purchase of a new luxury car is low. The probability of accepting the proposed offer (seed attempts succeeds) may follow the following equation:

$$Pv = {P}_{{Max}_{v}} \cdot ( \frac{min ( {θ}_{v} , \vert {N}_{v}^{+} ) \vert}{{θ}_{v}} ) .$$

Where Nᵥ⁺ is the set of indexes of the infected (Stᵥ=1) neighbors of customer v, and θᵥ is the minimal number of infected neighbors at p_{Max}_{ᵥ}.

If a seeding attempt succeeded or failed then the status of one or more node and/or the attractiveness score may or may not change.

The updates may include calculating Nᵥ⁺ (number of infected neighbors, for each node), as well as changes of states (Stᵥ) for nodes that require such a change.

The iterations of steps 440, 450 and 460 may end when the entire budget is depleted, or when all the nodes in the network becomes infected.

Step 430 and/or step 460 may calculate the attractiveness score in various manners. For example—the attractiveness score (also referred to as LVM score) may be calculated in a recursive or non-recursive manner.

The computation method to calculate the LVM score, is performed recursively, and is defined below for a depth of 3 recursion levels in eq. (2). The recursive computation of the score, for a depth of k iterations, is presented in the following algorithm, and is later named as the seeding strategies “picky_social_<k>”; i.e. “picky_social_0”, “picky_social_1” and “picky_social_2”, where picky_social_k computes the score for a depth of k recursions depth, or can be simply seen as the term p(v), picky_social_1 as p(v)*{1+Σ_{uεN}_{^{−}}₍ᵥ₎[p(u)]} and picky_social_2 as the full in eq. (2), etc. . . .

Score(v)=p(v)*{1+Σ_{uεN}_{^{−}}₍ᵥ₎[p(u)*(1+Σ_{wεN}_{^{−}}₍ᵤ₎p(w)]} (4)

The attractiveness score may calculated using the pseudo-code mentioned above (section The SSH Scoring Algorithm).

The recursive calculation of the LVM score, evaluates the expected value of seeding node v. First it calculates the probability of infecting v itself; i.e. p(v). Then, based on model hyper parameter—Level, it sums the additional value of v's neighborhood, as described in eq. (3) on 2 social circles, and so on. For example, the expected additional value of node u (v's 1^{st} degree neighbor, given the seeding of v is p(v)*p(u|v). Similarly, the expected value of node w; which is v's 2^{nd} circle neighbor, and u's 1^{st} circle neighbor is p(v)*p(u|v)*p(w|u,v)).

While the above function computes the scores at any level of k, as further seen in the result section, there is a tradeoff between the effort to foresee and the time of computation. In most cases, it seems as the right balance is in one single level of depth, that is, in setting the parameter k=1 or k=2 result in a good enough solution. At this depth of recursive, the results are rather good, but the additional computation complexity dramatically increases.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method—respectively.

Any of the methods may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments such as other parallel processing methods.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, clusters of computers, or commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for information spread in one or more social networks, the method comprises:
repeating multiple times, for each time period of multiple time periods, the steps of:
choosing, by a computer, a subset of nodes out of a set of nodes that represent users of the one or more social networks; wherein the choosing is based on attractiveness scores of the nodes of the set of nodes; wherein each attractiveness score represents a probability of an acceptance of a purchase offer of an item by a user that is represented by a node;
performing, by the computer, seeding attempts of the nodes of the subset of nodes; and
evaluating, by the computer, successes of the seeding attempts and updating at least one of a status and an attractiveness score of one or more nodes of the subset of nodes based on an outcome of the evaluating of the success of the seeding attempts; wherein a seeding attempt is deemed successful when determining that a user represented by a node accepts a purchase offer aimed to the user.

2. (canceled)

3. (canceled)

4. (canceled)

5. (canceled)

6. (canceled)

7. (canceled)

8. (canceled)

9. (canceled)

10. (canceled)

11. (canceled)

12. A method for information spread in one or more social networks, the method comprises:
receiving or generating social network information that represents members of the one or more social networks and links between the members;
repeating, for each point in time out of multiple points in time, the steps of:
determining, in response to budget constraints and current statuses of the members, at least one target member that is non-infected during the point of time and should be infected before the next point in time or in later points in time, to provide an increase in a number of infected members; wherein the statuses of the members comprises (i) infected and infectious, (ii) non-infected and (iii) infected and non-infectious; and
sending, at a cost, the information to the at least one target member, before the next point in time.

13. The method according to claim 12 wherein at least one status of at least one member is known approximately or estimated from observations.

14. The method according to claim 12 wherein the at least one target member comprises multiple members.

15. The method according to claim 12 wherein the determining of the at least one target member is responsive to failed seeding attempts of one or more members.

16. The method according to claim 12 wherein the determining of the at least one target member is responsive to a time period lapsed after previous seeding attempts

17. The method according to claim 12 wherein the social network information is a social network graph and wherein the members are nodes of the social network graph.

18. The method according to claim 12 comprising updating the statuses of the members before the next point of time.

19. The method according to claim 128 comprising receiving feedback about an actual status of the members before at least one next point in time and wherein the updating of the statuses is responsive to the feedback

20. The method according to claim 128 comprising receiving feedback about an estimated status of the members before at least one next point in time and wherein the updating of the statuses is responsive to the feedback

21. The method according to claim 128, wherein the sending of the information results in one or more infection attempts.

22. The method according to claim 12, wherein the determining of the at least one target member is responsive to an estimated relationship between infection attempts and infection success.

23. The method according to claim 12, wherein the determining of the at least one target member is responsive to at least one of an estimated model and a stochastic model of a relationship between infection attempts and infection success.

24. The method according to claim 12, wherein the determining of the at least one target member is responsive to a deterministic model of a relationship between infection attempts and infection success.

25. The method according to claim 24, wherein the deterministic model of the relationship between infection attempts and infection success dictates that a non-infected member becomes infected once a predefined number of neighbor members of the non-infected member are infected and infectious.

26. The method according to claim 12 comprising receiving feedback about a status of a target member wherein the status is indicative of whether the target member adopted at least one out of (a) a product which was advertised by the information sent to the target member, and (b) a service which was advertised by the information sent to the target member.

27. The method according to claim 12 wherein the determining of the at least one target member is responsive to a probabilistic model of a relationship between infection attempts and infection success, such that the expected values of the infection success will increase.

28. The method according to claim 27, wherein the probabilistic model of the relationship between infection attempts and infection success dictates that a probability of non-infected member to be infected increases with an increment of a number of neighbor members of the non-infected member that are infected and infectious

29. The method according to claim 27, wherein the probabilistic model of the relationship between infection attempts and infection success dictates that a probability of non-infected member to be infected increases with a number of infected neighbors until a defined number and does not further change.

30. The method according to claim 12, comprising changing a status of each infected and infectious member to be an infected and non-infectious member after a predefined period of time.

31. The method according to claim 12 comprising receiving external information about a given member and calculating a probability of a successful seeding related to the given member; and wherein the determining of the at least one target member is responsive to the probability of the successful seeding related to the given member.

32. The method according to claim 12, wherein the social network information is a social network graph and wherein the members are nodes of the social network graph; wherein the nodes are arranged in clusters; wherein the determining is responsive to the clusters.

33. The method according to claim 12 comprising repeating the steps of (a) receiving or generating of the social network information, and (b) determining, in response to budget constraints and current statuses of the members, at least one target member.

34. A non-transitory computer readable medium that stores instructions that once executed by a computer cause the computer to execute the steps of:
receiving or generating social network information that represents members of the one or more social networks and links between the members;
repeating, for each point in time out of multiple points in time, the steps of:
determining, in response to budget constraints and current statuses of the members, at least one target member that is non-infected during the point of time and should be infected before the next point in time, to provide a maximal number of infected members; wherein the statuses of the members comprises (i) infected and infectious, (ii) non-infected and (iii) infected and non-infectious; and
sending, at a cost, the information to the at least one target member, before the next point in time.
